(19) United States
(12) Patent Application Publication
(10) Pub. No.: US 2026/0003540 A1
(43) Pub. Date: Jan. 1, 2026

(54) STORAGE CONTROLLER AND STORAGE DEVICE INCLUDING THE SAME

(71) Applicant: Samsung Electronics Co., Ltd., Suwon-si (KR)

(72) Inventors: Yohan KO, Suwon-si (KR); Jae Young PARK, Suwon-si (KR); Sangkwon MOON, Suwon-si (KR); Hyunkyo OH, Suwon-si (KR)

(73) Assignee: Samsung Electronics Co., Ltd., Suwon-si (KR)

(21) Appl. No.: 19/048,045

(22) Filed: Feb. 7, 2025

(30) Foreign Application Priority Data
Jun. 27, 2024 (KR) 10-2024-0084636

(51) Int. Cl. G06F 3/06

(52) U.S. Cl. CPC G06F 3/0656; G06F 3/0619; G06F 3/0659; G06F 3/0688

(57) ABSTRACT

A storage controller configured to control first to N-th non-volatile memory devices respectively including first to N-th plurality of physical addresses is disclosed. The storage controller may comprise a relocation buffer circuit, a potential collision counter circuit configured to store a plurality of potential collision counts respectively corresponding to a plurality of combinations of the first to N-th plurality of physical addresses, a preliminary relocation circuit configured to store a first relocation candidate data which is stored in a first relocation candidate physical address in the relocation buffer circuit, based on a first plurality of potential collision counts, corresponding to the first relocation candidate physical address, among the plurality of potential collision counts, and a flush circuit configured to flush the first relocation candidate data from the relocation buffer circuit to one of the first to N-th non-volatile memory devices.

### CROSS-REFERENCE TO RELATED APPLICATION

This application claims priority to and the benefit of Korean Patent Application No. 10-2024-0084636 filed in the Korean Intellectual Property Office on Jun. 27, 2024, the entire contents of which is incorporated herein by reference.

### BACKGROUND

The present disclosure relates to semiconductor storage devices. More particularly, the present disclosure relates to storage controllers and storage devices including the same.

A storage device may include a plurality of non-volatile memory device storage controllers. The storage controller may control a plurality of non-volatile memory devices through a plurality of channels and a plurality of ways. For example, storage controller may read data stored in the plurality of non-volatile memory devices in response to a request from the external host device.

The speed of the storage controller reads a plurality of data from a plurality of non-volatile memory devices may vary depending on the similarity of the physical addresses where the plurality of data are stored. For example, when an external host device accesses a plurality of data stored in one or more non-volatile memory device connected to the same channel, compared to the case where the external host device accesses the plurality of data stored in one or more non-volatile memory devices connected to different channels, the storage controller may perform the read operation at a relatively slow speed.

### SUMMARY

The present disclosure is intended to solve the technical object described above. More specifically, the present disclosure attempts to provide a storage controller and a storage device including the same, configured to more rapidly perform the read operation.

In some example embodiments, a storage controller may be disclosed. The storage controller may be configured to control first to N-th non-volatile memory devices respectively including first to N-th plurality of physical addresses (wherein, N is an integer of 2 or more), the storage controller comprising: a relocation buffer circuit; a potential collision counter circuit configured to store a plurality of potential collision counts respectively corresponding to a plurality of combinations of the first to N-th plurality of physical addresses; a preliminary relocation circuit configured to store a first relocation candidate data which is stored in a first relocation candidate physical address in the relocation buffer circuit, based on a first plurality of potential collision counts, corresponding to the first relocation candidate physical address, among the plurality of potential collision counts; and a flush circuit configured to flush the first relocation candidate data from the relocation buffer circuit to one of the first to N-th non-volatile memory devices.

In some example embodiments, a storage device may be disclosed. The storage device may comprise a first non-volatile memory device configured to store a relocation candidate data; a second non-volatile memory device; and a storage controller configured to relocate the relocation candidate data from the first non-volatile memory device to the second non-volatile memory device, based on a first collision probability of when reading the relocation candidate data from the first non-volatile memory device and a second collision probability of when reading the relocation candidate data from the second non-volatile memory device.

In some example embodiments, a storage device may be disclosed. The storage device may comprise a plurality of non-volatile memory devices including a plurality of physical addresses; a command buffer circuit configured to store one or more read commands generated based on host commands provided from an external host device; and a data relocation manager configured to, during a first period, in response to a read command being added to the command buffer circuit, relocate data stored in a physical address corresponding to the added read command; and during a second period, relocate a plurality of data each stored in the plurality of physical addresses, sequentially, wherein an access from the external host device repeatedly occurs in the first period, and where the access from the external host device does not occur in the second period.

### BRIEF DESCRIPTION OF THE DRAWINGS

FIG. 1 is a block diagram showing a storage system according to some example embodiments of the present disclosure.

FIG. 2 is a block diagram showing the storage controller of FIG. 1 in more detail.

FIG. 3 is a block diagram showing the host interface circuit of FIG. 2 in more detail.

FIG. 4 and FIG. 5 are drawings showing examples of an operation of a storage controller based on the read commands of FIG. 3.

FIG. 6 is a drawing showing a method of relocating the relocation candidate data of FIG. 5 in more detail.

FIG. 7 is a drawing showing the potential collision count table of FIG. 2 in more detail.

FIG. 8 is a drawing showing the collision probability table of FIG. 2 implemented according to some example embodiments in more detail.

FIG. 9 is a drawing showing the relocation priority table of FIG. 2 in more detail.

FIG. 10 is a flowchart showing an operation of a storage controller according to some example embodiments.

FIG. 11 is a flowchart showing the step S1300 of FIG. 10 in more detail.

FIG. 12 is a flowchart showing the step S1350 of FIG. 11 in more detail.

FIG. 13 is a drawing showing the collision probability table of FIG. 2 implemented according to some example embodiments in more detail.

FIG. 14 is a flowchart showing an operation of a storage controller according to some example embodiments.

FIG. 15 is a drawing showing some examples of the neural network model of FIG. 1.

FIG. 16 is a timing diagram showing an operation of a storage controller storing weights necessary for the operation of the neural network model of FIG. 15.

FIG. 17 is a drawing showing an operation of a data relocation manager according to some example embodiments.

FIG. 18 is a drawing showing a collision probability table CPT according to some example embodiments of FIG. 17.

FIG. 19 is a drawing showing an operation of a data relocation manager according to some example embodiments.

FIG. 20 is a drawing showing a collision probability table according to some example embodiments of FIG. 18.

FIG. 21 to FIG. 23 are drawing showing the potential collision count table of FIG. 2 according to different example embodiments.

### DETAILED DESCRIPTION

Hereinafter, some example embodiments will be described in detail and clearly to such an extent that one skilled in the art easily carries out the present disclosure. The details such as components and structures described in the specification are merely provided to assist the overall understanding of the example embodiments. Therefore, it should be apparent to those skilled in the art that various changes and modifications of the example embodiments described herein may be made without departing from the scope and spirit of the present disclosure. Moreover, the descriptions of well-known functions and structures are omitted for the sake of clarity and brevity. In the following drawings or in the detailed description, components may be connected to any other components except for components that are illustrated in drawings or are described in the detailed description. The terms described below are terms defined in consideration of the functions and are not limited to a specific function. The definitions of the terms should be determined based on the contents throughout the specification.

Components that are described in the detailed description with reference to the terms “driver”, “controller”, “block”, etc. may be implemented with software, hardware, or a combination thereof. For example, the software may be a machine code, firmware, an embedded code, and application software. For example, the hardware may include an electrical circuit, an electronic circuit, a processor, a microprocessor, a computer, integrated circuit cores, a pressure sensor, an inertial sensor, a microelectromechanical system (MEMS), a passive element, or a combination thereof.

In addition, the term ‘circuit’ will refer to various components described below, but the scope of the present disclosure is not limited to the specific implementation of these components. For example, the components referred to as ‘circuit’ hereafter may be implemented as hardware, software, and/or a combination thereof. In other words, the components referred to as ‘circuit’ may be referred to by various terms such as ‘module’, ‘unit’, ‘block’, etc.

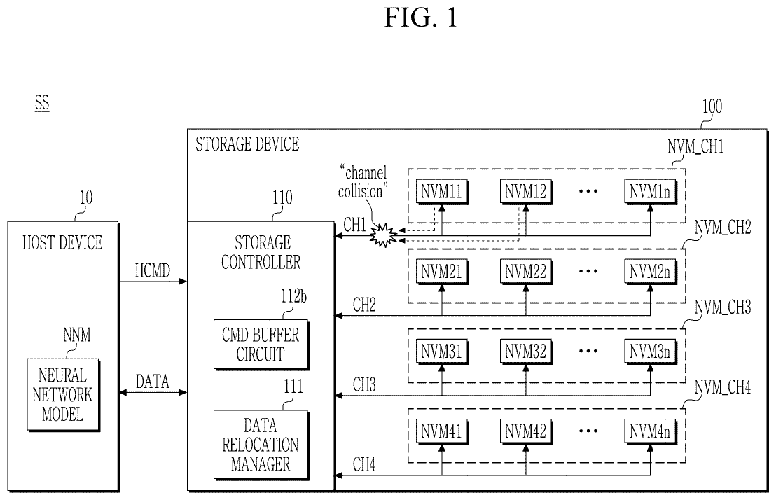

FIG. 1 is a block diagram showing a storage system according to some example embodiments of the present disclosure. Referring to FIG. 1, a storage system SS may include a host device 10 and a storage device 100.

The host device 10 may communicate with the storage device 100. For example, the host device 10 may transmit a host command HCMD to the storage device 100, and thereby may store data DATA in the storage device 100 or read the data DATA stored in the storage device 100.

In some example embodiments, the host device 10 may communicate with the storage device 100 based on various types of interfaces such as Nonvolatile Memory Express (NVMe) interface, Peripheral Component Interconnect Express (PCI-express) interface, and the like. However, the scope of the present disclosure is not limited thereto.

In some example embodiments, the host device 10 may drive a neural network model NNM. For example, the host device 10 may drive various types of artificial intelligence algorithms such as object recognition, large language model (LLM) based on the neural network model NNM. The host device 10 may read a plurality of weights used in driving of the neural network model NNM from the storage device 100.

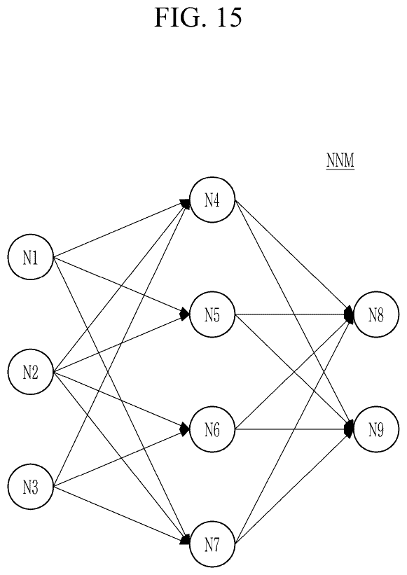

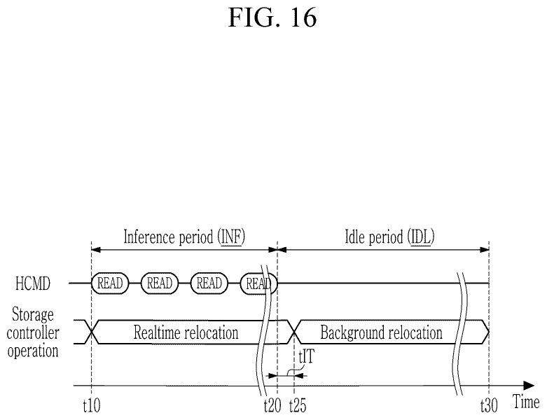

In some example embodiments, the host device 10 may repeatedly drive the neural network model NNM. In this case, the host device 10 may repeatedly read specific combination of two or more data from the storage device 100 depending on a configuration of the neural network model NNM. A configuration and operation of the neural network model NNM will be hereinafter described in more detail with reference to FIG. 15 and FIG. 16.

The storage device 100 may include a storage controller 110 and a plurality of non-volatile memory devices NVM.

The storage controller 110 may process various types of requests from the host device 10. For example, the storage controller 110 may include a command buffer circuit 112b. The command buffer circuit 112b may store a plurality of commands generated by parsing the host command HCMD.

The storage controller 110 may process the plurality of commands stored in the command buffer circuit 112b, sequentially or parallelly. For example, the storage controller 110 may transmit a command stored in the command buffer circuit 112b to the corresponding non-volatile memory device NVM, and thereby store data in the non-volatile memory device NVM or read data stored in the non-volatile memory device NVM. Hereinafter, some example embodiments in which the storage controller 110 processes a read command stored in the command buffer circuit 112b will be described representatively.

The storage controller 110 may be connected to the plurality of non-volatile memory devices NVM through first to fourth channels CH1 to CH4. For brevity of description, hereinafter, some example embodiments in which the storage device 100 includes four channels will be described representatively. However, the scope of the present disclosure is not limited to the number of channels included in the storage device 100. For example, the storage controller 110 may be connected to the plurality of non-volatile memory devices NVM through fewer or more channels than four.

The non-volatile memory devices NVM connected to an i-th channel CHi may be referred to as i-th channel non-volatile memory devices NVM_CHi (wherein (i) may be an integer greater than or equal to 1). For example, the non-volatile memory devices NVM connected to the first channel CH1 may be referred to as first channel non-volatile memory devices NVM_CH1.

The i-th channel non-volatile memory devices NVM_CHi may include the non-volatile memory devices NVMi1 to NVMin. For example, the first channel non-volatile memory devices NVM_CH1 may include the non-volatile memory devices NVM11 to NVM1n.

The storage controller 110 may be connected to the plurality of non-volatile memory devices NVM through a plurality of ways. For example, the storage controller 110 may be connected to each of the non-volatile memory devices NVMi1 to NVMin included in the i-th channel non-volatile memory devices NVM_CHi with different way.

For brevity of description, FIG. 1 representatively illustrates some example embodiments in which n-ways are formed for each channel, but the present disclosure is not limited thereto. For example, the storage controller 110 may be connected to the plurality of non-volatile memory devices NVM through different number of ways for each channel.

Each of a plurality of non-volatile memory devices NVM11 to NVM4n may store data or output the stored data under the control of the storage controller 110. In some example embodiments, each of the plurality of non-volatile memory devices NVM11 to NVM4n may be a NAND flash memory device. However, the scope of the present disclosure is not limited thereto.

The speed of the storage controller 110 reads data from the plurality of non-volatile memory devices NVM may vary depending on the similarity the physical addresses corresponding to the read commands stored in the command buffer circuit 112b. For example, the speed at which the storage controller 110 reads data from the plurality of non-volatile memory devices NVM may vary depending on various reasons, such as whether the physical addresses corresponding to the read commands stored in the command buffer circuit 112b correspond to the same channel, correspond to the same way, correspond to the same plane, or the like.

For a more specific example, the command buffer circuit 112b may store read commands with respect to the non-volatile memory devices NVM connected to different channels. For example, the command buffer circuit 112b may store the read commands with respect to the non-volatile memory devices NVM11 and NVM21. In this case, since the non-volatile memory devices NVM11 and NVM21 communicate with the storage controller 110 through different channels, the storage controller 110 may communicate with the non-volatile memory device NVM11 through the first channel CH1, and may communicate with the non-volatile memory device NVM21 through the second channel CH2 simultaneously. For example, while the data stored in the non-volatile memory device NVM11 is provided to the storage controller 110 through the first channel CH1, the data stored in the non-volatile memory device NVM21 may be provided to the storage controller 110 through the second channel CH2. That is, the storage controller 110 may parallelly process the read commands with respect to the non-volatile memory devices NVM11 and NVM21. In this case, the read speed of the storage controller 110 may be improved or maximized.

On the other hand, in some example embodiments, the command buffer circuit 112b may store the read commands with respect to the non-volatile memory devices NVM11 and NVM12 connected to the first channel CH1. In this case, since the non-volatile memory devices NVM11 and NVM12 share the same channel, the storage controller 110 may communicate with only one non-volatile memory device NVM at one time through the first channel CH1. For example, while the data stored in the non-volatile memory device NVM11 is provided to the storage controller 110 through the first channel CH1, the data stored in the non-volatile memory device NVM12 may not be provided to the storage controller 110 through the first channel CH1. That is, the read commands with respect to the non-volatile memory devices NVM11 and NVM12 may not be parallelly processed at the channel level, and accordingly, the read speed of the storage controller 110 may be deteriorated.

In some example embodiments, a phenomenon in which the read speed of the storage controller 110 deteriorates as a plurality of data are read through one channel may be referred to as “channel collision”. For example, the channel collision may occur when a plurality of data are read one by one from each of two or more non-volatile memory devices connected to one channel, or a plurality of data are read from one non-volatile memory device.

Meanwhile, when the command buffer circuit 112b store read commands with respect to the non-volatile memory devices NVM11 and NVM12 connected to the first channel CH1, the storage controller 110 may individually control the non-volatile memory devices NVM11 and NVM12. That is, the non-volatile memory devices NVM11 and NVM12 may independently operate in response to the control of the storage controller 110. In this case, while the read operation is performed within the non-volatile memory devices NVM11, the read operation may be performed within the non-volatile memory devices NVM12. For example, while data is prepared in the page buffer circuit within the non-volatile memory devices NVM11, data may be prepared in the page buffer circuit within the non-volatile memory devices NVM12.

However, in some example embodiments, the command buffer circuit 112b may store a plurality of read commands with respect to one non-volatile memory device. For example, the plurality of read commands corresponding to different physical addresses included in the non-volatile memory device NVM11, respectively may be stored in the command buffer circuit 112b. In this case, the non-volatile memory device NVM11 can only output data corresponding to one physical address at one time through the connected way. In other words, the storage controller 110 can only receive data corresponding to one physical address at one time from the non-volatile memory device NVM11. That is, the read commands with respect to the non-volatile memory device NVM11 may not be parallelly processed at the way level, and accordingly, the read speed of the storage controller 110 may be deteriorated.

In some example embodiments, a phenomenon in which the read speed of the storage controller 110 deteriorates as the read operation with respect to different physical addresses included in a single non-volatile memory device NVM is performed may be referred to as “way collision”. As used herein, a way may refer to a path used to communicate data between a controller and a given nonvolatile memory device. For example, non-volatile memory devices NVM11 to NVM1n may each be connected to the controller 110 through a common channel by respective ways. However, the example embodiments are not so limited thereto. For example, each physical page of a given non-volatile memory device may be connected to the controller 110 by respective ways through a common channel.

Meanwhile, when the command buffer circuit 112b stores the plurality of read commands with respect to one non-volatile memory device NVM11, the storage controller 110 may individually control different planes included in the non-volatile memory device NVM11. For example, each of a plurality of planes included in the non-volatile memory device NVM11 may perform independently read operation in response to the control of the storage controller 110. For a more specific example, each of the plurality of planes included in the non-volatile memory device NVM11 may be connected to different page buffer circuits. In this case, the non-volatile memory device NVM11 may simultaneously read data from each of the plurality of planes with plane interleaving scheme.

However, in some example embodiments, the command buffer circuit 112b may store a plurality of read commands with respect to one plane included in one non-volatile memory device. For example, the plurality of read commands corresponding to different physical addresses with respect to one plane within the non-volatile memory device NVM11 may be stored in the command buffer circuit 112b. In this case, the non-volatile memory device NVM11 can only read data corresponding to one physical address from one plane, and accordingly, the read speed of the storage controller 110 may be deteriorated. That is, one plane within the plurality of read commands with respect to the non-volatile memory device NVM11 may not be parallelly processed at the plane level, and accordingly, the read speed of the storage controller 110 may be deteriorated.

In some example embodiments, a phenomenon in which the read speed of the storage controller 110 deteriorates as a read operation with respect to different physical addresses included in a single plane is performed may be referred to as “plane collision”.

That is, the speed at which the storage controller 110 reads the plurality of data requested from the host device 10 from the plurality of non-volatile memory devices NVM may vary depending on the similarity of the physical address where the plurality of data are stored. For example, the speed at which the storage controller 110 reads data from the plurality of non-volatile memory devices NVM may vary depending on whether a channel collision, a way collision, and a plane collision occur.

The storage controller 110 may include a data relocation manager 111. The data relocation manager 111 may relocate the data stored in the plurality of non-volatile memory devices NVM so that the storage controller 110 may perform the read operation at a faster speed. For example, the data relocation manager 111 may distribute the plurality of data which are repeatedly accessed at substantially the same time point. to non-volatile memory devices connected to different channels.

For a more specific example, when the situation that the storage controller 110 accesses first data stored in the non-volatile memory device NVM11 and second data stored in the non-volatile memory device NVM12 substantially simultaneously (e.g., with a very short time interval) according to a request of the host device 10 repeatedly occurs, the data relocation manager 111 may relocate one of the first data and the second data to the non-volatile memory device (e.g., the non-volatile memory device NVM41) included in another channel. In this case, the storage controller 110 may simultaneously receive the first data and the second data from different channels, and accordingly, the read speed of the storage controller 110 may be improved.

Similarly, the data relocation manager 111 may distribute data read repeatedly and substantially simultaneously to the non-volatile memory devices connected to different ways; or to different planes. Hereinafter, for a more concise description, some example embodiments in which the data relocation manager 111 distributes (e.g., relocates) the plurality of data read repeatedly and substantially simultaneously, to non-volatile memory devices connected to different channels will be described representatively.

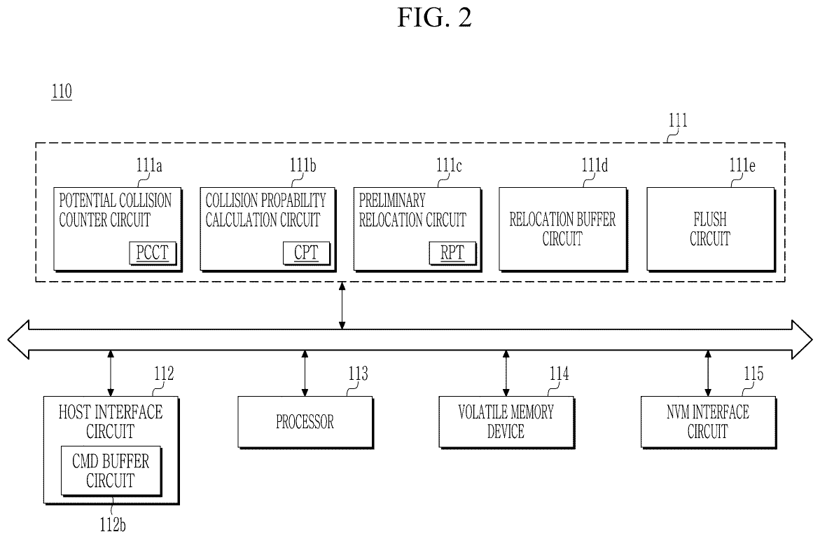

FIG. 2 is a block diagram showing the storage controller of FIG. 1 in more detail. Referring to FIG. 1 and FIG. 2, the storage controller 110 may include the data relocation manager 111, a host interface circuit 112, a processor 113, a volatile memory device 114, and a non-volatile memory device interface circuit 115. The data relocation manager 111, the host interface circuit 112, the processor 113, the volatile memory device 114, and the non-volatile memory device interface circuit 115 may be connected to each other through buses.

The storage controller 110 may communicate with the host device 10 through the host interface circuit 112. For example, the host interface circuit 112 may include at least one of various host interfaces such as a peripheral component interconnect express (PCI-express) interface, a non-volatile memory express (NVMe) interface, a serial ATA (SATA) interface, a serial attached SCSI (SAS) interface, a universal flash storage (UFS) interface, or the like. Hereinafter, for a more concise description, the host interface circuit 112 is assumed to communicate with the host device 10 based on the PCI-express interface.

The host interface circuit 112 may fetch the host command HCMD from the host device 10. The host interface circuit 112 may store the plurality of commands in the command buffer circuit 112b generated by parsing the host command HCMD. For example, the host interface circuit 112 may queue a plurality of commands to the command buffer circuit 112b.

The processor 113 may control an overall an operation of the storage controller 110. For example, the processor 113 may execute various types of applications executed in the storage controller 110 such as flash translation layer (FTL).

The volatile memory device 114 may be used as a buffer memory, an operating memory, or a cache memory of the storage controller 110. For example, the volatile memory device 114 may temporarily store the data read from the plurality of non-volatile memory devices NVM before providing it to the host device 10.

For example, the host interface circuit 112 may be implemented as a static random access memory (SRAM), a dynamic random access memory (DRAM), or the like.

In some example embodiments, the host device 10 may access the storage device 100 based on the logical address. On the other hand, the storage controller 110 may control the plurality of non-volatile memory devices NVM based on the physical address. Accordingly, the storage controller 110 may manage the logical address and the physical address by distinguishing the logical address and the physical address. For example, the volatile memory device 114 may store an address mapping table used for driving of the FTL. The address mapping table may represent an address mapping between a plurality of logical addresses and a plurality of physical addresses.

The storage controller 110 may communicate with the plurality of non-volatile memory devices NVM through the non-volatile memory device interface circuit 115. For example, the non-volatile memory device interface circuit 115 may communicate with the plurality of non-volatile memory devices NVM based on the NAND interface.

The data relocation manager 111 may include a potential collision counter circuit 111a, a collision probability calculation circuit 111b, a preliminary relocation circuit 111c, a relocation buffer circuit 111d, and a flush circuit 111e.

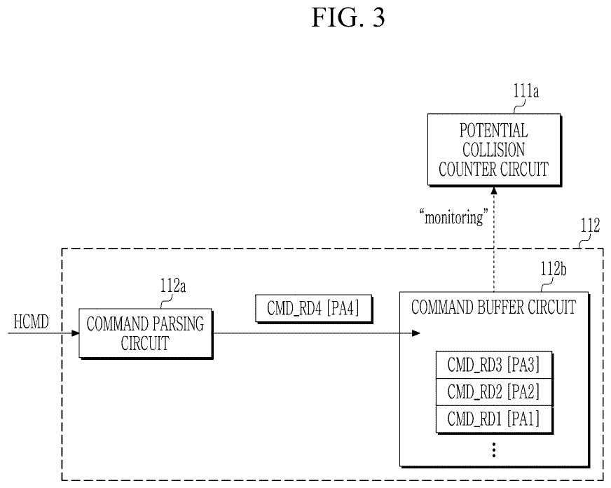

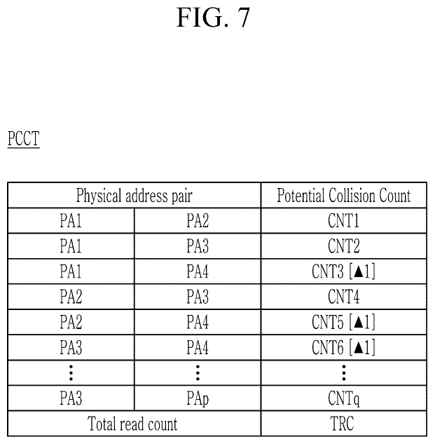

The potential collision counter circuit 111a may manage a potential collision count table PCCT. The potential collision count table PCCT may include a plurality of counts (hereinafter, may be referred to as “CNT”) corresponding to different combinations of the plurality of physical addresses, respectively. Each of a plurality of potential collision counts CNT may represent the number of times of which a corresponding combination of physical addresses is accessed substantially simultaneously. For example, each of the plurality of potential collision counts CNT may record the number of times of which read commands with respect to a corresponding combination of physical addresses are included in the command buffer circuit 112b at the same time point. The manner in which the potential collision counter circuit 111a manages the potential collision count table PCCT will described in more detail with reference to FIG. 3 and FIG. 7 below.

The collision probability calculation circuit 111b may generate a collision probability table CPT based on the potential collision count table PCCT. The collision probability table CPT may include a plurality of channels collision probabilities (hereinafter, may be referred to as “CCP”) with respect to data (hereinafter, may be referred to as relocation candidate data DATA_RC) stored in a specific physical address (hereinafter, may be referred to as a relocation candidate physical address PA_RC). A plurality of channel collision probabilities CCP with respect to the relocation candidate data DATA_RC may represent the channel collision occurrence probabilities at the time when the relocation candidate data DATA_RC are stored in the non-volatile memory devices NVM11 to NVM4n, respectively. In other words, the collision probability table CPT may include the channel collision occurrence probabilities at the time when reading the relocation candidate data DATA_RC from each of the non-volatile memory devices NVM11 to NVM4n.

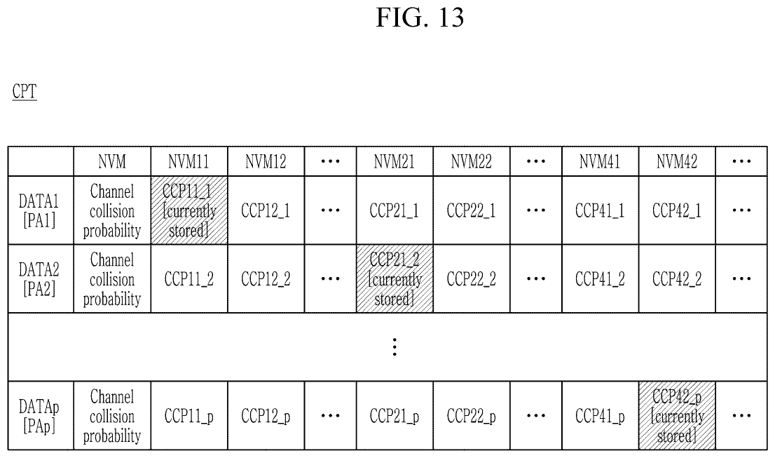

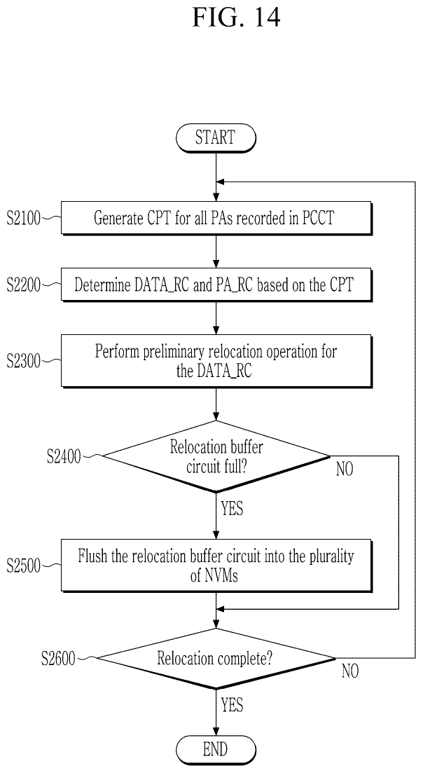

In some example embodiments, the collision probability table CPT may include the channel collision probabilities CCP with respect to the plurality of physical addresses. For example, the collision probability table CPT may represent the channel collision probabilities at the time when each of the plurality of data is stored in the non-volatile memory devices NVM11 to NVM4n. Some example embodiments in which the collision probability table CPT includes the channel collision probabilities CCP with respect to the plurality of physical addresses will be hereinafter described in more detail with reference to FIG. 13 and FIG. 14.

The preliminary relocation circuit 111c may generate a relocation priority table RPT based on the collision probability table CPT. The preliminary relocation circuit 111c may determine the non-volatile memory device to be most appropriate to relocate the relocation candidate data DATA_RC among the non-volatile memory devices NVM11 to NVM4n based on the relocation priority table RPT.

The preliminary relocation circuit 111c may store the relocation candidate data DATA_RC in the relocation buffer circuit 111d. For example, the preliminary relocation circuit 111c may store the relocation candidate data DATA_RC in a specific region within the relocation buffer circuit 111d based on the non-volatile memory device determined to be most appropriate to relocate the relocation candidate data DATA_RC.

In this way, the preliminary relocation circuit 111c may sequentially store a plurality of relocation candidate data DATA_RC in the relocation buffer circuit 111d.

In some example embodiments, the relocation buffer circuit 111d may be implemented as a volatile memory circuit such as a static random-access memory (SRAM), a dynamic random-access memory (DRAM), or the like.

The flush circuit 111e may flush one or more data stored in the relocation buffer circuit 111d to the plurality of non-volatile memory devices NVM. For example, the flush circuit 111e may program each in one or more relocation candidate data DATA_RC stored in the relocation buffer circuit 111d in an appropriate non-volatile memory device.

That is, the data relocation manager 111 may relocate the relocation candidate data DATA_RC included in a specific non-volatile memory device to the physical address included in another non-volatile memory device. In this case, when the read operation for the relocated relocation candidate data DATA_RC is performed simultaneously with the read operation for another physical address, the channel collision probability may be reduced or minimized. Therefore, as the data relocation manager 111 relocates the data stored in the plurality of non-volatile memory devices NVM, the read speed of the storage controller 110 may be improved. The more detailed function of each component of the data relocation manager 111 may be described in more detail with reference to the drawings below.

In some example embodiments, the data relocation manager 111 may be implemented by hardware, software, or a combination of hardware and software. For example, a part of components included in the data relocation manager 111 may be included in the storage controller 110 in the form of a dedicated circuit. In addition, at least a portion of the data relocation manager 111 may be implemented as a software module loaded to the volatile memory device 114 by the processor 113. That is, FIG. 2 representatively illustrates some example embodiments in which each component of the data relocation manager 111 is implemented as a separate circuit, but a part of components included in the data relocation manager 111 may be implemented as software, or may be included in other components included in the storage controller 110.

FIG. 3 is a block diagram showing the host interface circuit of FIG. 2 in more detail. Referring to FIG. 1 to FIG. 3, the host interface circuit 112 may include a command parsing circuit 112a and the command buffer circuit 112b.

The command buffer circuit 112b may store one or more read commands CMD_RD. For example, the command buffer circuit 112b may store first to third read commands CMD_RD1 to CMD_RD3. The first to third read commands CMD_RD1 to CMD_RD3 may correspond to the first to third physical addresses PA1 to PA3, respectively.

The storage controller 110 may perform read operations with respect to physical addresses corresponding to the one or more read commands CMD_RD stored in the command buffer circuit 112b. For example, the storage controller 110 may provide a first read command CMD_RD1 to the non-volatile memory device NVM including the first physical address PAL.

In some example embodiments, the storage controller 110 may delete the first read command CMD_RD1 from the command buffer circuit 112b after receiving the data stored in the first physical address PA1 (e.g., after the data of the first physical address PA1 is stored in the volatile memory device 114).

The command parsing circuit 112a may receive the host command HCMD. The command parsing circuit 112a may generate the one or more read commands CMD_RD by parsing the host command HCMD. For example, the command parsing circuit 112a may generate a fourth read command CMD_RD4 correspond to a fourth physical address PA4 by parsing the host command HCMD. The command parsing circuit 112a may provide the fourth read command CMD_RD4 to the command buffer circuit 112b.

The potential collision counter circuit 111a may monitor the command buffer circuit 112b. For example, the potential collision counter circuit 111a may monitor the physical address corresponding to the read command newly added to the command buffer circuit 112b (e.g., the fourth read command CMD_RD4 which is lastly added to the command buffer circuit 112b); and may monitor the physical addresses corresponding to the read commands already stored in the command buffer circuit 112b (e.g., the first to third read commands CMD_RD1 to CMD_RD3).

In some example embodiments, the read commands which are stored in the command buffer circuit 112b prior to the read command newly added to the command buffer circuit 112b may be referred to as ‘preceding read commands’. For example, the first to third read commands CMD_RD1 to CMD_RD3 may be referred to as preceding read commands for the fourth read command CMD_RD4.

The potential collision counter circuit 111a may update the potential collision count table PCCT based on the physical address corresponding to the read command newly added to the command buffer circuit 112b, and the physical addresses corresponding to preceding read commands thereto. For example, whenever the read command is newly added to the command buffer circuit 112b, the potential collision counter circuit 111a may increase the potential collision counts CNT respectively corresponding to one or more combinations composed of i) ‘one of the physical addresses corresponding to preceding read commands’ and ii) ‘physical address corresponding to the newly added read command’. A specific manner in which the potential collision counter circuit 111a updates the potential collision count table PCCT will be described in more detail with reference to FIG. 7 below.

That is, according to some example embodiments of the present disclosure, the potential collision counter circuit 111a may reflect the information with respect to the plurality of physical addresses of which the access is requested by the host device 10 substantially simultaneously (e.g., within a short time interval) to the potential collision count table PCCT.

In some example embodiments, each of a plurality of physical addresses PA may correspond to a different PPN (physical page number).

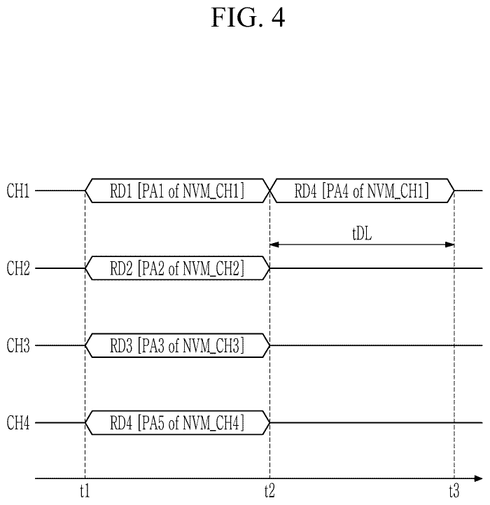

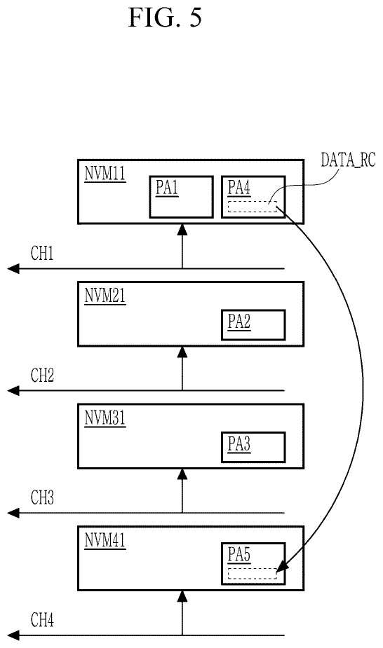

FIG. 4 and FIG. 5 are drawings showing examples of an operation of a storage controller based on the read commands of FIG. 3.

First, referring to FIG. 1 to FIG. 4, the storage controller 110 may process first to fourth read commands CMD_RD1 to CMD_RD4. The first to fourth read commands CMD_RD1 to CMD_RD4 may correspond to first to fourth physical addresses PA1 to PA4, respectively.

The first physical address PA1 may be included in the first channel non-volatile memory devices NVM_CH1; the second physical address PA2 may be included in the second channel non-volatile memory devices NVM_CH2; and the third physical address PA3 may be included in the third channel non-volatile memory devices NVM_CH3. For example, the first to third physical addresses PA1 to PA3 may be included in the non-volatile memory devices NVM11, NVM21, and NVM31, respectively.

The storage controller 110 may parallelly process the first to third read commands CMD_RD1 to CMD_RD3. For example, between a first time point t1 and a second time point t2, the storage controller 110 may parallelly perform a first read operation RD1 with respect to the first physical address PA1, a second read operation RD2 with respect to the second physical address PA2, and a third read operation RD3 with respect to the third physical address PA3.

The fourth physical address PA4 may be included in the first channel non-volatile memory devices NVM_CH1. For example, the fourth physical address PA4 may be included in the non-volatile memory device NVM11. In this case, the storage controller 110 may process the first read command CMD_RD1 and the fourth read command CMD_RD4 sequentially (e.g., one by one). For example, from the second time point t2, at which the first read operation RD1 is completed, to a third time point t3, the storage controller 110 may perform a fourth read operation RD4 with respect to the fourth physical address PA4.

That is, the fourth physical address PA4 and the first physical address PA1 correspond to the same channel, and the time required for the storage controller 110 to completely perform first to fourth read operations RD1 to RD4 may be delayed by an interval (e.g., a delay time tDL) between the second time point t2 and the third time point t3.

For a more concise description, FIG. 4 representatively illustrates some example embodiments in which the storage controller 110 performs the fourth read operation RD4 with respect to the fourth physical address PA4 after the first read operation RD1 with respect to the first physical address PA1 has been completed, but the present disclosure is not limited thereto. For example, the storage controller 110 may divide the data stored in the first physical address PA1 and a second physical address PA4 into small pieces and alternately read them. Even in this case, one channel can only transmit data with respect to one physical address at one time, and accordingly, the delay time tDL may occur.

Subsequently, referring also to FIG. 5, the data relocation manager 111 may relocate the relocation candidate data DATA_RC stored in the fourth physical address PA4 to a fifth physical address PA5. For example, the data relocation manager 111 may move the relocation candidate data DATA_RC from the non-volatile memory device NVM11 to the non-volatile memory device NVM41. In this case, the physical address corresponding to the fourth read command CMD_RD4 may be changed from the fourth physical address PA4 to the fifth physical address PA5.

Continuing to refer to FIG. 4, as shown in a dotted line, when the fourth read command CMD_RD4 corresponds to the fifth physical address PA5, the storage controller 110 may parallelly perform the first to fourth read operations RD1 to RD4 between the first time point t1 and the second time point t2.

That is, as the physical address corresponding to the fourth read command CMD_RD4 changes from the fourth physical address PA4 to the fifth physical address PA5, the time required for the storage controller 110 to completely perform the first to fourth read operations RD1 to RD4 may be shortened by the delay time tDL. Therefore, as the relocation candidate data DATA_RC are relocated according to some example embodiments of the present disclosure, the read speed of the storage controller 110 may be improved.

For a more concise description, FIG. 5 representatively illustrates some example embodiments in which the first physical address PA1 and the fourth physical address PA4 are included in one non-volatile memory device, but the present disclosure is not limited thereto. For example, the first physical address PA1 and the fourth physical address PA4 may be stored in two different non-volatile memory devices included in the first channel non-volatile memory devices NVM_CH1, respectively.

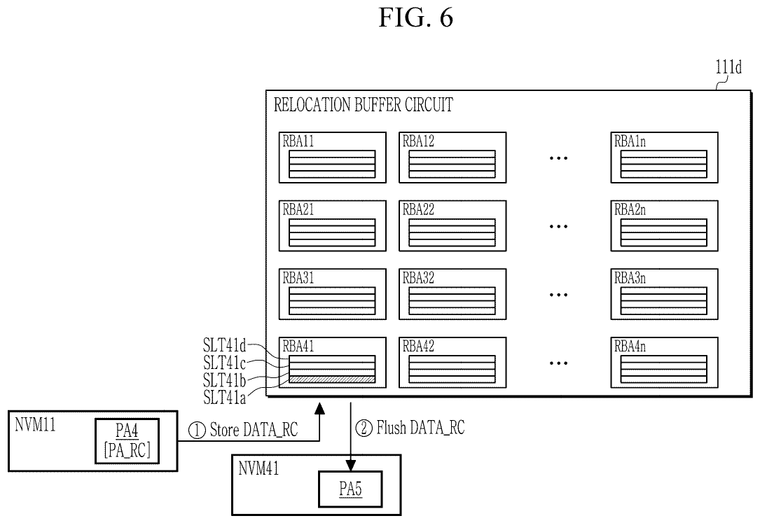

FIG. 6 is a drawing showing a method of relocating the relocation candidate data of FIG. 5 in more detail. Referring to FIG. 1 to FIG. 6, the relocation buffer circuit 111d may include a plurality of relocation buffer areas RBA. For example, the relocation buffer circuit 111d may include the plurality of relocation buffer areas RBA11 to RBA4n corresponding to the plurality of non-volatile memory devices NVM11 to NVM4n, respectively.

The preliminary relocation circuit 111c may read the relocation candidate data DATA_RC from the relocation candidate physical address PA_RC. For example, the preliminary relocation circuit 111c may read the relocation candidate data DATA_RC from the fourth physical address PA4 included in the non-volatile memory device NVM11.

In some example embodiments, the relocation candidate data DATA_RC may correspond to one physical page. For example, the capacity of the relocation candidate data DATA_RC may be the same as one physical page.

Each of the plurality of relocation buffer areas RBA11 to RBA4n may temporarily store the data relocated to the corresponding non-volatile memory device NVM. For example, the relocation buffer area RBA41 may temporarily store the data which is to be relocated to the non-volatile memory device NVM41.

Capacity of each of the plurality of relocation buffer areas RBA11 to RBA4n may be predetermined or alternatively desired. For example, each of the plurality of relocation buffer areas RBA11 to RBA4n may include four data slots SLT.

More specifically, a relocation buffer area RBAij may include first to fourth data slots SLTija to SLTijd (wherein, (i) and (j) may be an integer greater than or equal to 1). For example, the relocation buffer area RBA41 may include first to fourth data slots SLT41a to SLT41d. Each of the first to fourth data slots SLT41a to SLT41d may store data corresponding to one physical page. For example, each of the first to fourth data slots SLT41a to SLT41d may store different relocation candidate data DATA_RC.

For a more concise description, FIG. 6 representatively illustrates some example embodiments in which each of the plurality of relocation buffer areas RBA11 to RBA4n includes four data slots. However, the scope of the present disclosure is not limited thereto. For example, the number of data slots included in the plurality of relocation buffer areas RBA11 to RBA4n may be different from each other, and the number of data slots included in the plurality of relocation buffer areas RBA11 to RBA4n may be smaller than or larger than four.

The preliminary relocation circuit 111c may select one of the plurality of relocation buffer areas RBA11 to RBA4n based on the relocation priority table RPT. For example, the preliminary relocation circuit 111c may select a target relocation buffer area corresponding to the non-volatile memory device (e.g., the non-volatile memory device having a lowest channel collision probability or a highest relocation priority) that is most appropriate for relocation of the relocation candidate data DATA_RC, based on the relocation priority table RPT corresponding to the relocation candidate data DATA_RC.

The preliminary relocation circuit 111c may store the relocation candidate data DATA_RC in the target relocation buffer area. For example, the preliminary relocation circuit 111c may store the relocation candidate data DATA_RC in the relocation buffer area RBA41. For a more specific example, the preliminary relocation circuit 111c may sequentially store the relocation candidate data DATA_RC in the first to fourth data slots SLT41a to SLT41d included in the relocation buffer area RBA41. For example, the preliminary relocation circuit 111c may store the relocation candidate data DATA_RC in the first data slot SLT41a.

In some example embodiments, the target relocation buffer area may refer to the relocation buffer area RBA corresponding to the non-volatile memory device that is most appropriate for relocation of the relocation candidate data DATA_RC.

In some example embodiments, when the first data slot SLT41a is in an occupied state (e.g., a state that data is stored in the first data slot SLT41a), the preliminary relocation circuit 111c may store the relocation candidate data DATA_RC in the second data slot SLT41b.

In some example embodiments, when the data that has been stored in the fourth physical address PA4 is stored in the relocation buffer circuit 111d, the storage controller 110 may provide the data stored in the relocation buffer circuit 111d to the host device 10, in response to the read request for the relocation candidate data DATA_RC from the host device 10. For example, the storage controller 110 may perform the read operation with respect to the relocation candidate data DATA_RC stored in the relocation buffer circuit 111d, instead of performing the read operation with respect to the non-volatile memory device NVM11. The storage controller 110 may provide the relocation candidate data DATA_RC read from the relocation buffer circuit 111d to the host device 10. In this case, operation efficiency of the storage controller 110 and operation speed of the storage device 100 may be improved. However, the scope of the present disclosure is not limited thereto, and when the address mapping with respect to the fourth physical address PA4 has not been invalidated, the storage controller 110 may provide the relocation candidate data DATA_RC read by performing a read operation with respect to the non-volatile memory device NVM11 including the fourth physical address PA4 to the host device 10.

The flush circuit 111e may flush the plurality of relocation buffer areas RBA11 to RBA4n to the plurality of non-volatile memory devices NVM11 to NVM4n, respectively. For example, the flush circuit 111e may program the data included in the relocation buffer area RBA11 in the non-volatile memory device NVM11; and may be program the data included in the relocation buffer area RBA41 in the non-volatile memory device NVM41. In this way, the flush circuit 111e may program the data stored in the first to fourth data slots SLT41a to SLT41d in the non-volatile memory device NVM41.

In some example embodiments, the flush circuit 111e may flush the relocation buffer circuit 111d to the plurality of non-volatile memory devices NVM when the relocation buffer circuit 111d is in a full-state. However, the scope of the present disclosure is not limited thereto, and the flush circuit 111e may flush the corresponding relocation buffer area RBA to the corresponding non-volatile memory device NVM whenever one relocation buffer area RBA is in the full-state; or may flush the relocation buffer circuit 111d to the plurality of non-volatile memory devices NVM under the control of the processor 113. That is, the scope of the present disclosure may not be limited to a specific situation in which the flush circuit 111e performs the flush operation.

That is, the preliminary relocation circuit 111c may sequentially store the plurality of relocation candidate data DATA_RC in the relocation buffer circuit 111d. Thereafter, the flush circuit 111e may flush the data stored in the relocation buffer circuit 111d to the plurality of non-volatile memory devices NVM. In this case, the physical address of the relocation candidate data DATA_RC stored in the relocation buffer circuit 111d may be changed collectively (e.g., at the same time), and accordingly, the probability that the channel collision occurs when the relocation candidate data DATA_RC is read may decrease. Therefore, according to some example embodiments of the present disclosure, the read speed of the storage controller 110 may be improved.

In some example embodiments, when the relocation candidate data DATA_RC is stored in the relocation buffer circuit 111d, the storage controller 110 may update the address mapping table. For example, when the relocation candidate data DATA_RC is stored in the relocation buffer circuit 111d, the processor 113 may invalidate the address mapping corresponding to the relocation candidate physical address PA_RC. However, the scope of the present disclosure is not limited to a specific timing at which the storage controller 110 updates the address mapping table. For example, when the relocation buffer circuit 111d is flushed to the plurality of non-volatile memory devices NVM, the storage controller 110 may update the address mapping table.

FIG. 7 is a drawing showing the potential collision count table of FIG. 2 in more detail. Referring to FIG. 1 to FIG. 7, the potential collision count table PCCT may include the plurality of potential collision counts CNT. For example, the potential collision count table PCCT may include first to q-th potential collision counts CNT1 to CNTq.

The plurality of potential collision counts CNT may correspond to different combinations of the plurality of physical addresses PA, respectively. For example, the plurality of potential collision counts CNT may correspond to a plurality of combinations including two different physical addresses among the plurality of physical addresses PA included in the plurality of non-volatile memory devices NVM, respectively. For a more specific example, a first potential collision count CNT1 may correspond to the first and second physical addresses PA1 and PA2; a second potential collision count CNT2 may correspond to the first and third physical addresses PA1 and PA3; a third potential collision count CNT3 may correspond to the first and fourth physical addresses PA1 and PA4; a fourth potential collision count CNT4 may correspond to the second and third physical addresses PA2 and PA3; a fifth potential collision count CNT5 may correspond to the second and fourth physical addresses PA2 and PA4; and a sixth potential collision count CNT6 may correspond to the third and fourth physical addresses PA3 and PA4. Similarly, a q-th potential collision count CNTq may correspond to third and p-th physical addresses PA3 and PAp.

For a more concise description, hereinafter, some example embodiments in which each of the plurality of potential collision counts CNT corresponds to a combination of two physical addresses will be representatively described. However, the scope of the present disclosure is not limited thereto, and each of the plurality of potential collision counts CNT may correspond to a combination (e.g. tuple) of three or more physical addresses.

The potential collision counter circuit 111a may increase the potential collision count CNT corresponding to the physical address pair having the possibility of collision potentially. That is, the potential collision counter circuit 111a may increase the potential collision count CNT corresponding to the physical address pair storing data to be read repeatedly and substantially simultaneously. For example, as described above with reference to FIG. 4, in the state that the read commands with respect to the first to third physical addresses PA1 to PA3 is stored in the command buffer circuit 112b, if the fourth physical address PA4 is additionally stored in the command buffer circuit 112b, the potential collision counter circuit 111a may increase the third, fifth, and sixth potential collision counts CNT3, CNT5, and CNT6 by 1.

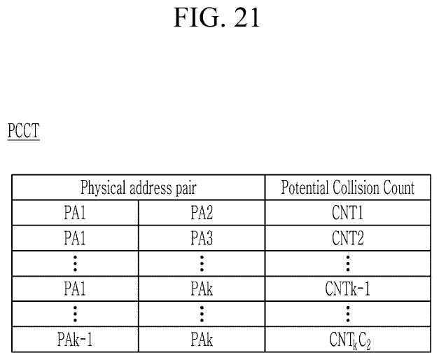

In some example embodiments, the potential collision count table PCCT may only include the potential collision counts CNT corresponding to a physical address pair storing data to be read substantially simultaneously. For example, when the data stored in the first and fifth physical addresses PA1 and PA5 have not been requested substantially simultaneously by the host device 10, the potential collision count table PCCT may not include a count corresponding to a combination of the first and fifth physical addresses PA1 and PA5. In this case, capacity of the potential collision count table PCCT may be reduced or minimized. However, the scope of the present disclosure is not limited thereto. The configuration of the potential collision count table PCCT implemented in another method will be hereinafter described in more detail with reference to FIG. 21 to FIG. 23.

In some example embodiments, when the relocation candidate data DATA_RC is added in the relocation buffer circuit 111d, the potential collision counter circuit 111a may update the physical addresses PA corresponding to each of the plurality of potential collision counts CNT. For example, the potential collision counter circuit 111a may change the relocation candidate physical address PA_RC recorded in the potential collision count table PCCT to an address of the data slot in which the relocation candidate data DATA_RC is stored. For a more specific example, the potential collision counter circuit 111a may change fourth physical addresses PA4 recorded in the potential collision count table PCCT (for example, physical addresses corresponding to the third, fifth, and sixth potential collision counts CNT3, CNT5, and CNT6) to an address of the data slot SLT41a. However, the scope of the present disclosure is not limited thereto, and the potential collision counter circuit 111a may update the relocation candidate physical address PA_RC recorded in the potential collision count table PCCT when the relocation buffer circuit 111d is flushed to the plurality of non-volatile memory devices NVM. For example, when the relocation buffer circuit 111d is flushed, the potential collision counter circuit 111a may change the fourth physical addresses PA4 each recorded in the potential collision count table PCCT (for example, physical addresses corresponding to the third, fifth, and sixth potential collision counts CNT3, CNT5, and CNT6) to the fifth physical address PA5.

In some example embodiments, the potential collision count table PCCT may be initialized (e.g. reset) based on the control of the processor 113. For example, the potential collision counter circuit 111a may decrease all the potential collision count CNT included in the potential collision count table PCCT to 0 in response to the control of the processor 113.

In some example embodiments, the potential collision counter circuit 111a may count the number of times by which the storage controller 110 provided the read command to the plurality of non-volatile memory devices NVM after the potential collision count table PCCT has been initialized. For example, the potential collision count table PCCT may include a total read count TRC. The total read count TRC may represent the number of times by which the storage controller 110 provided the read command to the plurality of non-volatile memory devices NVM after the potential collision count table PCCT has been initialized.

In some example embodiments, the potential collision count table PCCT may further include a total collision count (not shown). The total collision count may represent a sum of all the potential collision counts CNT included in the potential collision count table PCCT.

In some example embodiments, the data relocation manager 111 may sequentially relocate the plurality of data included in the plurality of non-volatile memory devices NVM based on the potential collision count table PCCT.

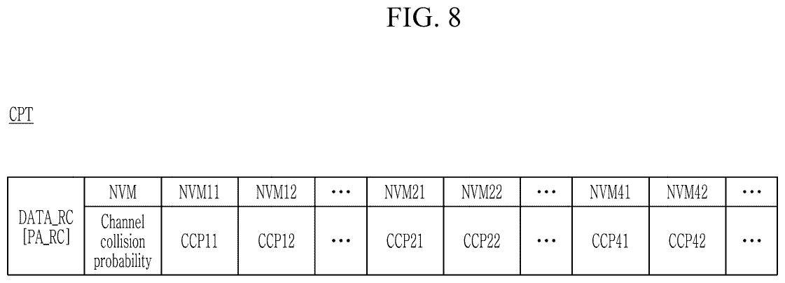

In some example embodiments, the data relocation manager 111 may be configured to relocate the data stored in the physical address corresponding to the added read command, whenever a read command is added to the command buffer circuit 112b. Some example embodiments in which the data relocation manager 111 relocates the data stored in the physical address corresponding to the added read command whenever the read command is added thereto will be hereinafter described in more detail with reference to FIG. 8 to FIG. 12.

In some example embodiments, the data relocation manager 111 may be configured to sequentially relocate the plurality of data respectively stored in the plurality of physical addresses, according to the collision probabilities corresponding to the non-volatile memory devices currently storing the plurality of data. Some example embodiments in which the data relocation manager 111 sequentially relocates each of the plurality of data stored in the plurality of physical addresses will be hereinafter described in more detail with reference to FIG. 13 to FIG. 14.

FIG. 8 is a drawing showing the collision probability table of FIG. 2 implemented according to some example embodiments in more detail. Hereinafter, some example embodiments in which the data relocation manager 111 stores one relocation candidate data DATA_RC corresponding to the read command last added to the command buffer circuit 112b to the command buffer circuit 112b will be described. However, the scope of the present disclosure is not limited thereto.

Referring to FIG. 1 to FIG. 8, the collision probability table CPT with respect to the relocation candidate data DATA_RC may include the plurality of channel collision probabilities CCP corresponding to the plurality of non-volatile memory devices NVM, respectively. For example, the collision probability table CPT with respect to the relocation candidate data DATA_RC may include the channel collision probabilities CCP11 to CCP4n corresponding to the cases where the relocation candidate data DATA_RC is stored in the plurality of non-volatile memory devices NVM11 to NVM4n, respectively.

More specifically, each of the channel collision probabilities CCP11 to CCP4n may represent the probability that the channel collision occurs when the relocation candidate data DATA_RC is read in case of the relocation candidate data DATA_RC is stored in the corresponding non-volatile memory device NVM. For example, the channel collision probability CCP11 may represent the probability that the channel collision occurs when the relocation candidate data DATA_RC is read in case of the relocation candidate data DATA_RC is stored in the non-volatile memory device NVM11. In other words, the channel collision probability CCP11 may represent a probability to read data from another non-volatile memory device connected to the same channel (e.g., the first channel CH1) as the non-volatile memory device NVM11, when the storage controller 110 reads the relocation candidate data DATA_RC from the non-volatile memory device NVM11.

In some example embodiments, the channel collision probabilities corresponding to the non-volatile memory devices connected to the same channel may be the same. For example, the channel collision probabilities CCP11 to CCP1n may be the same. For a more specific example, each of the channel collision probabilities CCP11 to CCP1n may represent a value obtained by dividing the total read count TRC from a sum of counts corresponding to combinations composed of: i) ‘one of the physical addresses included in the first channel non-volatile memory devices NVM_CH1’ and ii) ‘the relocation candidate physical address PA_RC’.

That is, according to some example embodiments of the present disclosure, the collision probability table CPT may represent that which non-volatile memory device NVM would be the most appropriate to store the relocation candidate data DATA_RC. For example, the preliminary relocation circuit 111c may identify the non-volatile memory device NVM corresponding to the lowest channel collision probability CCP as the non-volatile memory device NVM most appropriate for storing the relocation candidate data DATA_RC.

For a more concise description, FIG. 8 representatively illustrates some example embodiments in which the collision probability table CPT includes the plurality of channel collision probabilities CCP corresponding to the plurality of non-volatile memory devices NVM, respectively, but the present disclosure is not limited thereto. For example, the collision probability table CPT may include a plurality of channel collision ratios corresponding to the plurality of non-volatile memory devices NVM, respectively. In this case, each of the plurality of channel collision ratios may represent a value obtained by dividing by the total collision count (e.g., a sum of all counts included in the potential collision count table) from a sum of counts corresponding to combinations composed of i) ‘one of the physical addresses included in the non-volatile memory device NVM’ and ii) ‘the relocation candidate physical address PA_RC’, respectively.

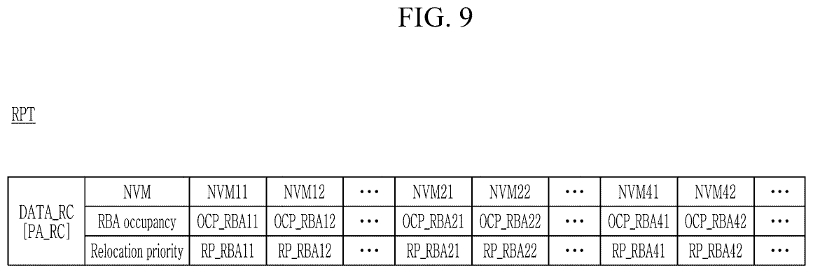

FIG. 9 is a drawing showing the relocation priority table of FIG. 2 in more detail. Referring to FIG. 1 to FIG. 9, the relocation priority table RPT with respect to the relocation candidate data DATA_RC may include a plurality of relocation buffer area occupancy rates OCP_RBA11 to OCP_RBA4n and a plurality of relocation priorities RP_RBA11 to RP_RBA4n corresponding to the plurality of relocation buffer areas RBA11 to RBA4n, respectively.

The plurality of relocation buffer area occupancy rates OCP_RBA11 to OCP_RBA4n may represent the occupancy rates of the plurality of relocation buffer areas RBA11 to RBA4n, respectively. For example, the relocation buffer area occupancy rate OCP_RBA11 may represent the occupancy rate of the relocation buffer area RBA11. For a more specific example, the relocation buffer area occupancy rate OCP_RBA11 may represent the ratio of total data slots within the relocation buffer area RBA11 to the data slots in an occupied state (e.g., a state of having stored data) within the relocation buffer area RBA11.

The preliminary relocation circuit 111c may calculate the plurality of relocation priorities RP_RBA11 to RP_RBA4n based on the channel collision probabilities CCP11 to CCP4n and the plurality of relocation buffer area occupancy rates OCP_RBA11 to OCP_RBA4n, respectively. For example, the preliminary relocation circuit 111c may calculate the relocation priority RP_RBA11 based on the channel collision probability CCP11 and the relocation buffer area occupancy rate OCP_RBA11.

In some example embodiments, the preliminary relocation circuit 111c may calculate the relocation priority RP_RBA11 by multiplying the channel collision probability CCP11 and the relocation buffer area occupancy rate OCP_RBA11. However, the scope of the present disclosure is not limited to a specific relationship with respect to the channel collision probability CCP11 and the relocation buffer area occupancy rate OCP_RBA11 of the relocation priority RP_RBA11. For example, the relocation priority RP_RBA11 may be calculated through any function such as a sum, weighted sum, or the like of the channel collision probability CCP11 and the relocation buffer area occupancy rate OCP_RBA11.

The preliminary relocation circuit 111c may determine the target relocation buffer area based on the relocation priority table RPT. For example, the preliminary relocation circuit 111c may determine the relocation buffer area RBA corresponding to the highest relocation priority RP_RBA as the target relocation buffer area. The preliminary relocation circuit 111c may store the relocation candidate data DATA_RC in the target relocation buffer area.

That is, according to some example embodiments of the present disclosure, the preliminary relocation circuit 111c may determine the target relocation buffer area in consideration of an occupancy rate of each of the plurality of relocation buffer areas RBA. In this case, repeatedly storing of the relocation candidate data DATA_RC only in a specific relocation buffer area may be prevented or reduced in likelihood.

In some example embodiments, the collision probability table CPT and the relocation priority table RPT may vary depending on the relocation candidate data DATA_RC. Therefore, the preliminary relocation circuit 111c may independently determine the relocation buffer area RBA to store each of the plurality of relocation candidate data DATA_RC.

In some example embodiments, when the total read count TRC is lower than a predetermined or alternatively desired threshold value, the preliminary relocation circuit 111c may not store the relocation candidate data DATA_RC in the command buffer circuit 112b. However, the scope of the present disclosure is not limited thereto. For example, the preliminary relocation circuit 111c may not store the relocation candidate data DATA_RC in the command buffer circuit 112b until a predetermined or alternatively desired time elapses after the total read count TRC has been increased from 0 to 1. In this case, unnecessary relocation of the relocation candidate data DATA_RC due to the total read count TRC is lower than a predetermined or alternatively desired threshold value may be prevented or reduced in likelihood.

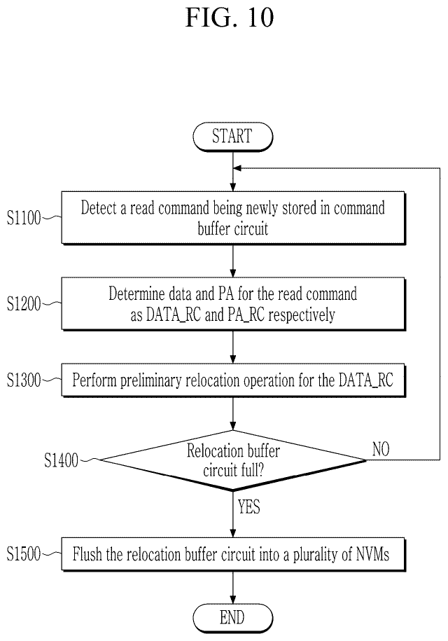

FIG. 10 is a flowchart showing an operation of a storage controller according to some example embodiments. Referring to FIG. 1 to FIG. 10, at step S1100, the storage controller 110 may detect the read command newly stored in the command buffer circuit 112b. For example, the potential collision counter circuit 111a may detect the read command last added to in the command buffer circuit 112b.

At step S1200, the storage controller 110 may determine the data and physical address for the detected read command as the relocation candidate data DATA_RC and the relocation candidate physical address PA_RC, respectively. For example, the data relocation manager 111 may determine the physical address corresponding to the read command last added to the command buffer circuit 112b as the relocation candidate physical address PA_RC, and may determine the data stored in the relocation candidate physical address PA_RC as the relocation candidate data DATA_RC.

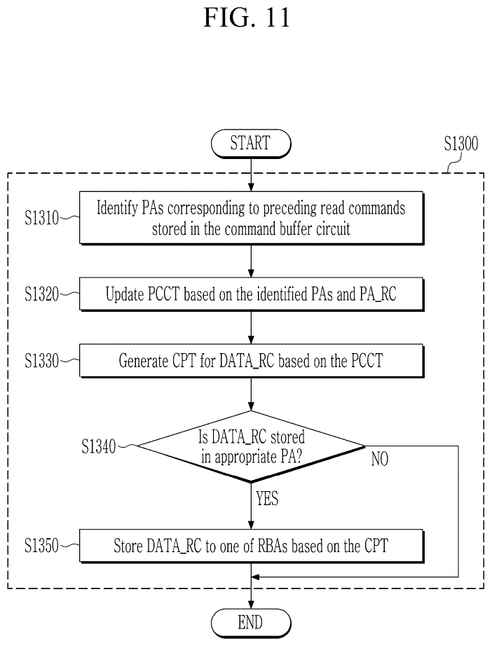

At step S1300, the storage controller 110 may perform the preliminary relocation operation with respect to the relocation candidate data DATA_RC. The step S1300 will be hereinafter described in more detail with reference to FIG. 11 to FIG. 13.

In some example embodiments, when the total read count TRC is lower than a predetermined or alternatively desired threshold value, the storage controller 110 may not perform the step S1300. In this case, unnecessary relocation of the relocation candidate data DATA_RC may be prevented or reduced in likelihood.

In some example embodiments, the storage controller 110 may omit performing of the step S1300 until a predetermined or alternatively desired time length elapses after the time point when the total read count TRC has been increased from 0 to 1. In this case, unnecessary relocation of the relocation candidate data DATA_RC may be prevented or reduced in likelihood.

At step S1400, the storage controller 110 may determine whether the relocation buffer circuit 111d is in the full-state. For example, the flush circuit 111e may determine whether the relocation buffer circuit 111d is in the state in which it cannot store the relocation candidate data DATA_RC anymore.

When it is determined that the relocation buffer circuit 111d is in the full-state, step S1500 described below may be performed; and when it is determined that the relocation buffer circuit 111d is not in the full-state, the step S1100 described above may be repeatedly performed. That is, according to some example embodiments of the present disclosure, whenever a new read command is stored to the command buffer circuit 112b, the storage controller 110 may perform the step 1100 to the step S1400 described above.

At step S1500, the storage controller 110 may flush the relocation buffer circuit 111d to the plurality of non-volatile memory devices NVM. For example, the flush circuit 111e may program one or more relocation candidate data DATA_RC stored in the relocation buffer circuit 111d in the plurality of non-volatile memory devices NVM.

In some example embodiments, after the step S1500 is performed, the storage controller 110 may repeatedly perform the S1100 described above. In this case, as the plurality of relocation candidate data DATA_RC are sequentially relocated, the read speed of the storage controller 110 may be gradually improved.

In some example embodiments, the flush circuit 111e may flush the relocation buffer circuit 111d to the plurality of non-volatile memory devices NVM in response to the control of the processor 113, regardless of the step S1400. Some example embodiments in which the flush circuit 111e performs the flush operation regardless of the step S1400 will be hereinafter described in more detail with reference to FIG. 16.

In some example embodiments, the step S1100 to the step S1500 described above may be performed during a section in which the host device 10 repeatedly accesses the storage device 100.

FIG. 11 is a flowchart showing the step S1300 of FIG. 10 in more detail. Referring to FIG. 1 to FIG. 11, the step S1300 may include the step 1310 to the step S1350 described below.

At step S1310, the potential collision counter circuit 111a may identify the physical addresses corresponding to preceding read commands stored in the command buffer circuit 112b. For example, the potential collision counter circuit 111a may identify physical addresses correspond to the read commands already stored in the command buffer circuit 112b.

At step S1320, the potential collision counter circuit 111a may update the potential collision count table PCCT based on the identified physical addresses and the relocation candidate physical address PA_RC. For example, the potential collision counter circuit 111a may increase the counts corresponding to the combinations composed of the relocation candidate physical address PA_RC and one of the physical addresses identified through the step S1310, by 1.

At step S1330, the collision probability calculation circuit 111b may generate the collision probability table CPT for the relocation candidate data DATA_RC based on the potential collision count table PCCT. For example, the collision probability calculation circuit 111b may calculate the channel collision probabilities CCP11 to CCP4n, based on counts corresponding to the relocation candidate physical address PA_RC among the potential collision counts CNT included in the potential collision count table PCCT.

At step S1340, the preliminary relocation circuit 111c may determine whether the relocation candidate data DATA_RC is stored in the appropriate physical address PA based on the collision probability table CPT. For example, the preliminary relocation circuit 111c may determine whether the channel collision probability of the relocation candidate data DATA_RC with respect to the non-volatile memory device storing the relocation candidate data DATA_RC is lower than a predetermined or alternatively desired threshold value.

When it is determined that the relocation candidate data DATA_RC is stored in the appropriate physical address PA, the step S1350 described below may be performed, and when it is determined that the relocation candidate data DATA_RC is not stored in the appropriate physical address PA, the step S1300 may be terminated. That is, according to some example embodiments of the present disclosure, when the relocation candidate data DATA_RC is already stored in the physical address PA, the storage controller 110 may not relocate the corresponding relocation candidate data DATA_RC. That is, when the relocation candidate data DATA_RC is already stored in the appropriate physical address PA, the relocation candidate data DATA_RC may be maintained in the relocation candidate physical address PA_RC.

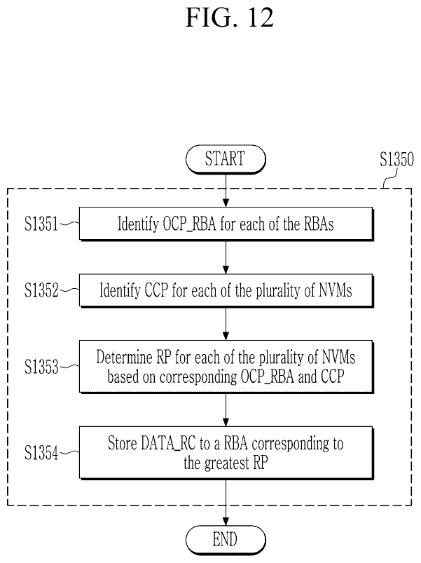

At step S1350, the preliminary relocation circuit 111c may store the relocation candidate data DATA_RC in one of the plurality of relocation buffer areas RBA based on the collision probability table CPT. The step S1350 will be hereinafter described in more detail with reference to FIG. 12.

FIG. 12 is a flowchart showing the step S1350 of FIG. 11 in more detail. Referring to FIG. 1 to FIG. 12, the step S1350 may include the step 1351 to the step S1354 described below.

At step S1351, the preliminary relocation circuit 111c may identify the relocation buffer area occupancy rate OCP_RBA for each of the plurality of relocation buffer areas RBA. For example, the preliminary relocation circuit 111c may store the relocation buffer area occupancy rates OCP_RBA11 to OCP_RBA4n in a relocation priority table RCT.

At step S1352, the preliminary relocation circuit 111c may identify the channel collision probability CCP for each of the plurality of non-volatile memory devices NVM. For example, the preliminary relocation circuit 111c may read the channel collision probabilities CCP11 to CCP4n from the collision probability table CPT.

At step S1353, the preliminary relocation circuit 111c may determine a relocation priority RP for each of the plurality of non-volatile memory devices NVM based on the channel collision probability CCP and relocation buffer area occupancy rate OCP_RBA corresponding thereto. For example, the preliminary relocation circuit 111c may calculate the plurality of relocation priorities RP_RBA11 to RP_RBA4n based on the plurality of channel collision probabilities CCP11 to CCP4n and the plurality of relocation buffer area occupancy rates OCP_RBA11 to OCP_RBA4n, respectively.

At step S1354, the preliminary relocation circuit 111c may store the relocation candidate data DATA_RC in the relocation buffer area RBA corresponding to the greatest relocation priority RP. For example, when the relocation priority RP_RBA41 is greatest among the plurality of relocation priorities RP_RBA11 to RP_RBA4n, the preliminary relocation circuit 111c may determine the relocation buffer area RBA41 as the target relocation buffer area. The preliminary relocation circuit 111c may store the relocation candidate data DATA_RC in the target relocation buffer area.

FIG. 13 is a drawing showing the collision probability table of FIG. 2 implemented according to some example embodiments in more detail. Hereinafter, some example embodiments in which the data relocation manager 111 selects one of the plurality of data stored in the plurality of non-volatile memory devices NVM and stores it in the command buffer circuit 112b will be described.

FIG. 1 to FIG. 7 and referring to FIG. 13, the potential collision count table PCCT may include records for first to p-th physical addresses PA1 to PAp. For example, the potential collision count table PCCT may include the plurality of potential collision counts CNT corresponding to combinations of the first to p-th physical addresses PA1 to PAp. The first to p-th physical addresses PA1 to PAp may store first to p-th data DATA1 to DATAp, respectively.

The collision probability calculation circuit 111b may generate the collision probability table CPT for all of the physical addresses PA recorded in the potential collision count table PCCT. For example, the collision probability calculation circuit 111b may calculate a plurality of channel collision probabilities CCP for each of the first to p-th data DATA1 to DATAp.

More specifically, with respect to i-th data DATAi, the collision probability calculation circuit 111b may calculate the channel collision probabilities CCP11_i to CCP4n_i respectively corresponding to the plurality of non-volatile memory devices NVM11 to NVM4n. For example, with respect to the first data DATA1, the collision probability calculation circuit 111b may calculate the plurality of channel collision probabilities CCP11_1 to CCP4n_1 respectively corresponding to the plurality of non-volatile memory devices NVM11 to NVM4n; and with respect to the second data DATA2, may calculate the plurality of channel collision probabilities CCP11_2 to CCP4n_2 respectively corresponding to the plurality of non-volatile memory devices NVM11 to NVM4n.

For a more concise description, FIG. 13 representatively illustrates some example embodiments in which the collision probability calculation circuit 111b generates the collision probability table CPT for all of the physical addresses PA recorded in the potential collision count table PCCT. However, the scope of the present disclosure is not limited thereto, and the storage controller 110 may generate the collision probability table CPT for all of the physical addresses PA included in the plurality of non-volatile memory devices NVM.

The preliminary relocation circuit 111c may determine the relocation candidate data DATA_RC and the relocation candidate physical address PA_RC, by comparing the channel collision probabilities CCP of the first to p-th data DATA1 to DATAp currently stored in. For example, as shown with stripe in FIG. 13, the preliminary relocation circuit 111c may determine a non-volatile memory device NVM with the greatest channel collision probability among the channel collision probabilities of the first to p-th data DATA1 to DATAp currently stored in (e.g., the channel collision probabilities CCP11_1 and CCP21_2, CCP42_p, and so on), as the relocation candidate physical address PA_RC. The preliminary relocation circuit 111c may determine the data included in the relocation candidate physical address PA_RC as the relocation candidate data DATA_RC.

Therefore, according to some example embodiments depicted in FIG. 13, the data having a highest channel collision probability may be determined as the relocation candidate data DATA_RC. In this case, the data having the highest channel collision probability may be relocated with high priority, and therefore, even if a smaller number of data are relocated, the read speed of the storage controller 110 may be significantly improved.

For a more concise description, FIG. 13 representatively illustrates some example embodiments in which the collision probability calculation circuit 111b generates the plurality of channel collision probabilities CCP for each of the plurality of data DATA and determines the relocation candidate data DATA_RC and the relocation candidate physical address PA_RC. However, the scope of the present disclosure is not limited to a specific manner in which the collision probability calculation circuit 111b determines the relocation candidate data DATA_RC and the relocation candidate physical address PA_RC. For example, the collision probability calculation circuit 111b may determine a physical address having the greatest number of corresponding counts within the potential collision count table PCCT as the relocation candidate physical address PA_RC. In this case, similarly to what described above with reference to FIG. 8 (e.g., unlike shown in FIG. 13), the collision probability calculation circuit 111b may calculate the channel collision probabilities CCP corresponding to the relocation candidate data DATA_RC.

FIG. 14 is a flowchart showing an operation of a storage controller according to some example embodiments. Referring to FIG. 1 to FIG. 7, and FIG. 13 to FIG. 14, at step S2100, the storage controller 110 may generate the collision probability table CPT for all of the physical addresses PA recorded in the potential collision count table PCCT. For example, the collision probability calculation circuit 111b may calculate the channel collision probabilities CCP11_1 to CCP4n_p.

At step S2200, the storage controller 110 may determine the relocation candidate data DATA_RC and the relocation candidate physical address PA_RC based on the collision probability table CPT. For example, the preliminary relocation circuit 111c may determine data, which is corresponding to the highest channel collision probability for the non-volatile memory device currently storing thereof, among the first to p-th data DATA1 to DATAp as the relocation candidate data DATA_RC. The preliminary relocation circuit 111c may determine the physical address in which the relocation candidate data DATA_RC is stored as the relocation candidate physical address PA_RC.

At step S2300, the storage controller 110 may perform the preliminary relocation operation with respect to the relocation candidate data DATA_RC.

At step S2400, the storage controller 110 may determine whether the relocation buffer circuit 111d is in the full-state. When it is determined that the relocation buffer circuit 111d is in the full-state, step S2500 below may be performed, and when it is determined that the relocation buffer circuit 111d is not in the full-state, the step S2200 described above may be repeatedly performed.

At step S2500, the storage controller 110 may flush the relocation buffer circuit 111d to the plurality of non-volatile memory devices NVM.

The step S2300 to the step S2500 are similar to the step S1300 to the step S1500 described above, and is not described in further detail.

At step S2600, the storage controller 110 may determine whether the relocation has been completed. For example, the storage controller 110 may determine whether the relocation operation is completed based on whether a predetermined or alternatively desired number of data have been relocated. However, the scope of the present disclosure is not limited thereto. For example, the storage controller 110 may determine whether the relocation operation is completed based on whether all data included in the plurality of non-volatile memory devices NVM have been relocated at least once.

When it is determined that the relocation operation has been completed, the operation of the storage controller 110 may be terminated. When the relocation operation has not been completed, the step S2200 described above may be repeatedly performed.

In some example embodiments, the step S2100 to the step S2600 described above may be performed during the section in which the host device 10 does not access the storage device 100.

In some example embodiments, unlike shown in FIG. 14, even when the relocation buffer circuit 111d is not in a full-state, the storage controller 110 may flush the relocation buffer circuit 111d to the plurality of non-volatile memory devices NVM. For example, when the host command is issued from the host device 10, the storage controller 110 may flush the relocation buffer circuit 111d to the plurality of non-volatile memory devices NVM even when the relocation buffer circuit 111d is not in a full-state.

FIG. 15 is a drawing showing an example of the neural network model of FIG. 1. Referring to FIG. 1 to FIG. 15, the neural network model NNM may include a plurality of operation nodes (N). For example, the neural network model NNM may include first to ninth operation nodes N1 to N9.

In some example embodiments, the neural network model may employ one or more neural network (NN) architecture among a multilayer perceptron (MLP) architecture, a convolutional neural network (CNN) architecture, a region with convolution neural network (R-CNN) architecture, a region proposal network (RPN) architecture, a recurrent neural network (RNN) architecture, a stacking-based deep neural network (S-DNN) architecture, a state-space dynamic neural network (S-SDNN) architecture, a deconvolution network architecture, a deep belief network (DBN) architecture, a restricted Boltzmann machine (RBM) architecture, a fully convolution network architecture, a classification network architecture, a plain residual network architecture, a dense network architecture, a hierarchical pyramid network architecture, a transformer architecture, a long short-term memory (LSTM) architecture, etc.

Each of the first to ninth operation nodes N1 to N9 may generate one or more output signals by multiplying one or more input signals by different weights. For example, a fourth operation node N4 may provide output signals, generated by multiplying each of the input signal received from first to third operation nodes N1 to N3 by different weights, to eighth to ninth operation nodes N8 to N9; and a sixth operation node N6 may provide output signals, generated by multiplying each of the input signal received from first to third operation nodes N1 to N3 by different weights, to the eighth to ninth operation nodes N8 to N9.

Some of the first to ninth operation nodes N1 to N9 may operate substantially at the same time point. For example, when the host device 10 executes the neural network model NNM, fourth and sixth operation nodes N4 and N6 may always operate at substantially the same time point. Therefore, when the host device 10 reads the weights necessary for an operation of the fourth operation node N4 from the storage device 100, and the host device 10 may also read the weights necessary for an operation of the sixth operation node N6 from the storage device 100. In this way, the host device 10 may always issue host commands HCMD with respect to the weights necessary for the operation of the fourth operation node N4 and host commands HCMD with respect to the weights necessary for the operation of the sixth operation node N6 at near time points.

The storage controller 110 may recognize that specific data set (e.g., the weights necessary for the operation of the fourth operation node N4 and the weights necessary for the operation of the sixth operation node N6) are always read at similar time points. For example, the storage controller 110 may detect the situations simultaneously repeatedly occurs that in which the read commands for the weights need for the operation of the fourth operation node N4 and the read commands for the weights need for the operation of the sixth operation node N6 are included in the command buffer circuit 112b. In this case, the storage controller 110 may relocate the weights need for the operation of the fourth operation node N4 and the weights need for the operation of the sixth operation node N6. Therefore, according to some example embodiments of the present disclosure, when the weights need for the operation of the fourth operation node N4 and the weights necessary for the operation of the sixth operation node N6 are accessed from the host device 10, the storage controller 110 may parallelly read them in the channel level, and accordingly, the read speed of the storage controller 110 may be improved.

FIG. 16 is a timing diagram showing an operation of a storage controller storing weights necessary for the operation of the neural network model of FIG. 15. Referring to FIG. 1 to FIG. 16, a neural network NNM may perform an inference operation between a tenth time point t10 and a twentieth time point t20. The period in which the neural network NNM performs the inference operation may be referred to as an inference period INF.

During the inference period INF, the host device 10 may repeatedly issue the host read commands READ for reading the weights necessary for the operation of the neural network model NNM to the storage device 100.

During the inference period INF, the storage controller 110 may perform a real-time relocation operation. For example, similar to described above with reference to FIG. 8 to FIG. 12, whenever a read command is added to the command buffer circuit 112b, the storage controller 110 may relocate data corresponding thereto.

The neural network NNM may be in an idle state between the twentieth time point t20 and a thirtieth time point t30. The period in which the neural network NNM is in the idle state may be referred to as an idle period IDL.

During the idle period IDL, the host device 10 may not access the storage device 100. For example, during the idle period IDL, the host device 10 may not issue the host command HCMD to the storage device 100.

When the host command HCMD is not received from the host device 10 for an idle transition time tIT, the storage controller 110 may recognize that the neural network NNM has entered the idle period IDL. For example, the storage controller 110 may recognize that the neural network NNM has entered the idle period IDL at a twenty-fifth time point t25 at which the idle transition time tIT has elapsed from the twentieth time point t20 (at which the host command HCMD was lastly received from the host device 10). In this case, the storage controller 110 may perform a background relocation operation. For example, similar to what was described above with reference to FIG. 13 to FIG. 14, the storage controller 110 may sequentially relocate the plurality of data DATA stored in the plurality of non-volatile memory devices NVM.

For brevity of description, FIG. 16 illustrates some example embodiments in which entry into the idle period IDL of the neural network NNM is recognized based on the time elapsed after the storage controller 110 has received the last host command HCMD, but the present disclosure is not limited thereto. For example, the storage controller 110 may recognize that the host device 10 has entered the idle period IDL based on receiving a predetermined or alternatively desired number of host commands HCMD from the host device 10, or receiving predefined host command HCMD that notifies that the neural network NNM has entered the idle period IDL.

In some example embodiments, the neural network model NNM may enter the inference period INF at the thirtieth time point t30. The storage controller 110 may recognize entry into the inference period INF of the neural network NNM based on receiving the host command HCMD from the host device 10. In this case, the storage controller 110 may terminate the background relocation operation and perform a real-time relocation operation.

In some example embodiments, when the storage controller 110 has recognized entering of the idle period IDL or the inference period INF of the neural network NNM, the storage controller 110 may control the flush circuit 111e through the processor 113 and thereby flush one or more data stored in the relocation buffer circuit 111d to the plurality of non-volatile memory devices NVM. For example, even if the relocation buffer circuit 111d are not in the full-state at the twenty-fifth time point t25 and the thirtieth time point t30, the storage controller 110 may flush one or more data stored in the relocation buffer circuit 111d to the plurality of non-volatile memory devices NVM.

In some example embodiments, when the storage controller 110 has completed the background relocation operation, the storage controller 110 may initialize (e.g. reset) the potential collision count table PCCT. For example, when the storage controller 110 has recognized entry into the inference period INF of the neural network NNM, the processor 113 may control the potential collision counter circuit 111a to decrease all the potential collision counts CNT and the total read count TRC included in the potential collision count table PCCT to 0. However, the scope of the present disclosure is not limited thereto.

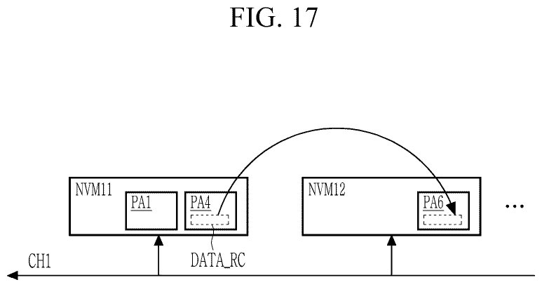

FIG. 17 is a drawing showing an operation of a data relocation manager according to some example embodiments. Referring to FIG. 1 to FIG. 17, the data relocation manager 111 may relocate the relocation candidate data DATA_RC stored in the fourth physical address PA4 to a sixth physical address PA6. For example, the data relocation manager 111 may move the relocation candidate data DATA_RC from the non-volatile memory device NVM11 to the non-volatile memory device NVM12. In this case, when the relocation candidate data DATA_RC is accessed simultaneously with the first physical address PA1, the storage controller 110 may parallelly perform the read operations with respect to the non-volatile memory device NVM11 and the non-volatile memory device NVM12. In other words, according to some example embodiments depicted in FIG. 17, the way collision occurred as the first physical address PA1 and the fourth physical address PA4 are accessed substantially simultaneously may be prevented or reduced in likelihood, and accordingly, the read speed of the storage controller 110 may be improved.

In some example embodiments, according to the example embodiments of FIG. 17, even if more physical addresses than the number of channels included in the storage device 100 are accessed substantially simultaneously access, the probability of way collision may be reduced or otherwise minimized, and the read speed of the storage controller 110 may be improved.

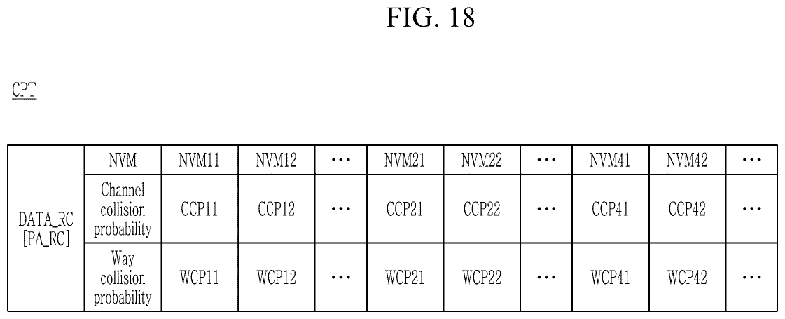

FIG. 18 is a drawing showing the collision probability table CPT according to some example embodiments of FIG. 17. Referring to FIG. 1 to FIG. 18, the collision probability table CPT with respect to the relocation candidate data DATA_RC may include the plurality of channel collision probabilities CCP and a plurality of way collision probabilities WCP corresponding to the plurality of non-volatile memory devices NVM, respectively. For example, the collision probability table CPT for the relocation candidate data DATA_RC may include the channel collision probabilities CCP11 to CCP4n and way collision probabilities WCP11 to WCP4n corresponding to the cases where the relocation candidate data DATA_RC is stored in the plurality of non-volatile memory devices NVM11 to NVM4n, respectively. The channel collision probabilities CCP11 to CCP4n are similar to what was described above with reference to FIG. 8, and is not described in further detail.

Each of the way collision probabilities WCP11 to WCP4n may represent the probability that the way collision occurs when the relocation candidate data DATA_RC is read in case of the relocation candidate data DATA_RC is stored in the corresponding non-volatile memory device NVM. For example, the way collision probability WCP11 may represent the probability that the way collision occurs when the relocation candidate data DATA_RC is read in case of the relocation candidate data DATA_RC is stored in the non-volatile memory device NVM11. In other words, the way collision probability WCP11 may represent the probability of that the storage controller 110 should read another data together from the non-volatile memory device NVM11 when the storage controller 110 reads the relocation candidate data DATA_RC from the non-volatile memory device NVM11. That is, the way collision probability WCP11 may represent a value obtained by dividing by the total read count TRC from a sum of counts corresponding to combinations composed of i) ‘one of the physical addresses included in the non-volatile memory device NVM11F’ and ii) ‘the relocation candidate physical address PA_RC’.

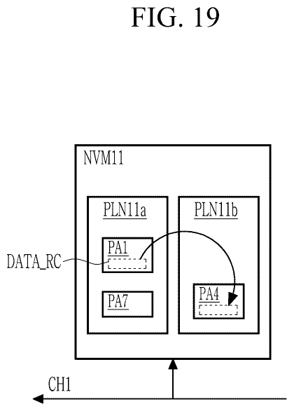

FIG. 19 is a drawing showing an operation of a data relocation manager according to some example embodiments. Referring to FIG. 1 to FIG. 16, and FIG. 19, the non-volatile memory device NVM11 may include the plurality of planes PLN. For example, the non-volatile memory device NVM11 may include a first plane PLN11a and a second plane PLN11b. Hereinafter, some example embodiments in which the non-volatile memory device NVM11 includes two planes will be representatively described. However, the scope of the present disclosure is not limited to the number of planes included in the non-volatile memory device NVM11.

In some example embodiments, each of the plurality of non-volatile memory devices NVM11 to NVM4n may include two planes. For example, a non-volatile memory device NVMij may include a first plane PLNija and a second plane PLNijb.

The first plane PLN11a and the second plane PLN11b may be connected to different bit lines. For example, the first plane PLN11a may be connected to a first plurality of bitlines, and the second plane PLN11b may be connected to a second plurality of bitlines.

The first plane PLN11a and the second plane PLN11b may be connected to different page buffer circuits. For example, the first plane PLN11a may be connected to a first page buffer circuit through the first plurality of bitlines, and the second plane PLN11b may be connected to a second page buffer circuit through the second plurality of bitlines. Therefore, while data is being read from the first plane PLN11a, data may be read from the second plane PLN11b.

In some example embodiments, first and second planes PLN11a to PLN11b may share a plurality of data pins. For example, the first page buffer circuit and the second page buffer circuit may share one input/output circuit connected to the first channel CH1 through a way.

The data relocation manager 111 may relocate the relocation candidate data DATA_RC stored in the first physical address PA1 to the fourth physical address PA4. For example, the data relocation manager 111 may move the relocation candidate data DATA_RC from the first plane PLN11a to the second plane PLN11b. In this case, when the relocation candidate data DATA_RC is accessed simultaneously with a seventh physical address PA7, the read operations with respect to the first plane PLN11a and the second plane PLN11b may be parallelly performed (e.g., in the plane interleaving method). In other words, according to some example embodiments of FIG. 17, the plane collision occurred as the first physical address PA1 and the seventh physical address PA7 are accessed substantially simultaneously may be prevented or reduced in likelihood, and accordingly, the read speed of the storage controller 110 may be improved.

In some example embodiments, according to the example embodiments of FIG. 19, even if more physical addresses than the multiplication of the number of channels and the number of ways are accessed substantially simultaneously, the probability of plane collision may be minimized or otherwise reduced, and the read speed of the storage controller 110 may be improved.

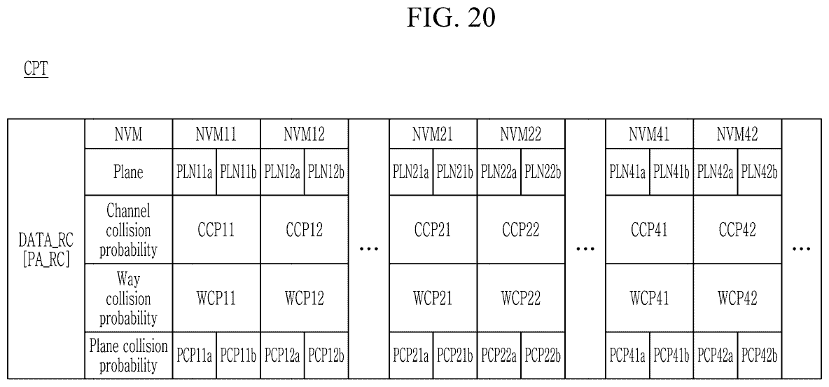

FIG. 20 is a drawing showing a collision probability table according to some example embodiments depicted in FIG. 18. The collision probability table CPT with respect to the relocation candidate data DATA_RC may include the plurality of channel collision probabilities CCP and the plurality of way collision probabilities WCP corresponding to the plurality of non-volatile memory devices NVM, respectively. The plurality of channel collision probabilities CCP and the plurality of way collision probabilities WCP are similar to what was described above with reference to FIG. 18, and is not described in further detail.

The collision probability table CPT with respect to the relocation candidate data DATA_RC may include a plurality of plane collision probabilities PCP corresponding to the plurality of planes PLN, respectively included in the plurality of non-volatile memory devices NVM.

For example, the collision probability table CPT for the relocation candidate data DATA_RC may include plane collision probabilities PCP11a to PCP4na respectively corresponding to first planes of the plurality of non-volatile memory devices NVM11 to NVM4n, and plane collision probabilities PCP11b to PCP4nb respectively corresponding to second planes of the plurality of non-volatile memory devices NVM11 to NVM4n.

More specifically, each of the plane collision probabilities PCP11a to PCP4na and the plane collision probabilities PCP11b to PCP4nb may represent the probability that the plane collision occurs when the relocation candidate data DATA_RC is read in case of the relocation candidate data DATA_RC is stored in the corresponding plane. For example, the plane collision probability PCP11a may represent the probability that the plane collision occurs when the relocation candidate data DATA_RC is read in case of the relocation candidate data DATA_RC is stored in the first plane PLN11a.

In other words, the plane collision probability PCP11a may represent the probability of that the storage controller 110 should read another data together from the first plane PLN11a when the storage controller 110 reads the relocation candidate data DATA_RC from the first plane PLN11a. That is, the plane collision probability PCP11a may represent a value obtained by dividing by the total read count TRC from a sum of counts corresponding to combinations composed of: i) ‘one of the physical addresses included in the first plane PLN11a’ and ii) ‘the relocation candidate physical address PA_RC’.

FIG. 21 to FIG. 23 are drawing showing the potential collision count table of FIG. 2 according to some different example embodiments.

Referring to FIG. 1 to FIG. 16, and FIG. 21, the total number of the physical address PA included in the plurality of non-volatile memory devices NVM may be ‘k’.

The potential collision count table PCCT may include the potential collision count CNT corresponding to all combinations implemented by two physical addresses among first to k-th physical addresses PA1 to PAk. For example, the potential collision count table PCCT may include first to (ₖC₂)-th potential collision counts CNT1 to CNTₖC₂. In this case, the first to (ₖC₂)-th potential collision counts CNT1 to CNTₖC₂ may respectively correspond to different combinations implemented by the two physical addresses among first to k-th physical addresses PA1 to PAk. That is, the potential collision counter circuit 111a may manage a potential collision count with respect to all combinations of the first to k-th physical addresses PA1 to PAk.

In some example embodiments, the potential collision count table PCCT may not store the physical address corresponding to each of the first to (ₖC₂)-th potential collision counts CNT1 to CNTₖC₂. For example, a combination of physical addresses corresponding to the first to (ₖC₂)-th potential collision counts CNT1 to CNTₖC₂ may be represented according to the position where the first to (ₖC₂)-th potential collision counts CNT1 to CNTₖC₂ are stored. In this case, the potential collision count table PCCT may not store the first to k-th physical addresses PA1 to PAk, and accordingly, capacity of the potential collision count table PCCT may be minimized or otherwise reduced.

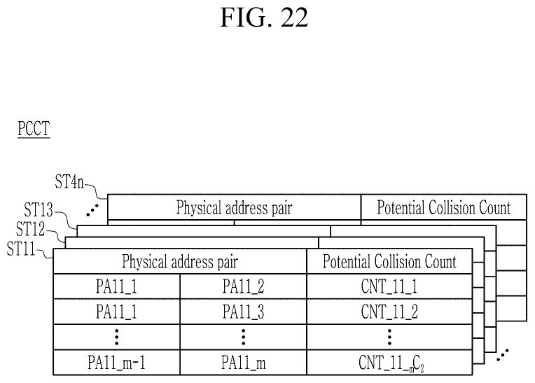

Referring to FIG. 1 to FIG. 16, and FIG. 22, the potential collision count table PCCT may include a plurality of sub-tables ST. For example, the potential collision count table PCCT may include a plurality of sub-tables ST11 to ST4n corresponding to the plurality of non-volatile memory devices NVM11 to NVM4n, respectively.

Each of the plurality of sub-tables ST11 to ST4n may include the potential collision count CNT corresponding to all combinations implemented by all physical addresses included in two physical addresses among the corresponding non-volatile memory device NVM. For example, the non-volatile memory device NVM11 may include the first to m-th physical addresses PA11_1 to PA11_m. In this case, sub-table ST11 may include first to (ₘC₂)-th potential collision counts CNT11_1 to CNT11_mC₂. The first to (ₘC₂)-th potential collision counts CNT11_1 to CNT11_mC₂ may respectively correspond to different combinations implemented by two physical addresses among the first to m-th physical addresses PA11_1 to PA11_m. In this case, the number of the potential collision count CNT included in the potential collision count table PCCT may decrease, and accordingly, the capacity of the potential collision count table PCCT may be minimized or otherwise reduced.

That is, the potential collision counter circuit 111a may individually manage the count value for each non-volatile memory device NVM. However, the scope of the present disclosure is not limited thereto, and the potential collision counter circuit 111a may manage the count value for each channel. In this case, the potential collision count table PCCT may include a sub-table corresponding to all combinations implemented by two physical addresses among all physical addresses included in the first channel non-volatile memory devices NVM_CH1 and a sub-table corresponding to all combinations implemented by two physical addresses among all physical addresses included in the second channel non-volatile memory devices NVM_CH2.

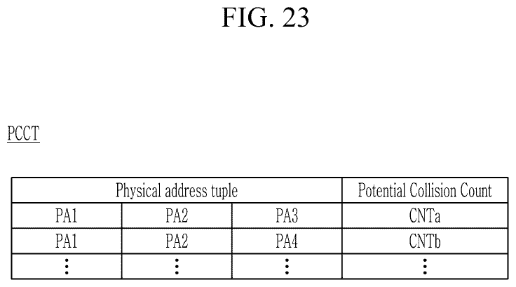

Referring to FIG. 1 to FIG. 16, and FIG. 23, the potential collision count table PCCT may include the plurality of potential collision counts CNT. The plurality of potential collision counts CNT may correspond to different combinations of the plurality of physical addresses, respectively. For example, the plurality of potential collision counts CNT may correspond to a plurality of tuples including three different physical addresses among the plurality of physical addresses included in the plurality of non-volatile memory devices NVM, respectively.

For a more specific example, a first potential collision count CNTa may correspond to the tuple including the first, second, and third physical address PA1, PA2, and PA3; and a second potential collision count CNTb may correspond to the tuple including the first, second, and fourth physical address PA1, PA2, and PA4.

When all the read commands with respect to a combination of the plurality of physical addresses are included in the command buffer circuit 112b, the potential collision counter circuit 111a may increase the count. For example, when the read commands with respect to the first, second, and third physical address PA1, PA2, and PA3 are all included in the command buffer circuit 112b, the first potential collision count CNTa may be increased by 1. In this case, the potential collision count table PCCT may reflect that the data stored in the three physical addresses are accessed substantially simultaneously. Therefore, according to some example embodiments of FIG. 23, the data relocation manager 111 may relocate the relocation candidate data DATA_RC in an improved method.

For a more concise description, FIG. 23 representatively illustrates some example embodiments in which one tuple includes three physical addresses, but the present disclosure is not limited thereto. For example, one tuple may include the four or more physical addresses. In this case, one potential collision count CNT may correspond to four or more physical addresses.

Any or all of the elements described with reference to the figures may communicate with any or all other elements described with reference to the respective figures. For example, any element may engage in one-way and/or two-way and/or broadcast communication with any or all other elements, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

The above-described contents are some specific example embodiments for implementing the present disclosure. The present disclosure will include not only the above-described embodiments, but also embodiments that may be simply design-changed or easily changed. In addition, the present disclosure will also include techniques that may be easily modified and implemented by using the example embodiments. While the present disclosure has been described with reference to example embodiments thereof, it will be apparent to those of ordinary skill in the art that various changes and modifications may be made thereto without departing from the spirit and scope of the disclosure as set forth in the following claims.

What is claimed is:

1. A storage controller configured to control first to N-th non-volatile memory devices respectively including first to N-th plurality of physical addresses (wherein, N is an integer of 2 or more), the storage controller comprising:
a relocation buffer circuit;
a potential collision counter circuit configured to store a plurality of potential collision counts respectively corresponding to a plurality of combinations of the first to N-th plurality of physical addresses;
a preliminary relocation circuit configured to store a first relocation candidate data which is stored in a first relocation candidate physical address in the relocation buffer circuit, based on a first plurality of potential collision counts, corresponding to the first relocation candidate physical address, among the plurality of potential collision counts; and
a flush circuit configured to flush the first relocation candidate data from the relocation buffer circuit to one of the first to N-th non-volatile memory devices.

2. The storage controller of claim 1, wherein:
the relocation buffer circuit includes a first to N-th relocation buffer areas corresponding to the first to N-th non-volatile memory devices, respectively;
the preliminary relocation circuit is further configured to determine a first target relocation buffer area, which is one of the first to N-th relocation buffer areas, based on the first plurality of potential collision counts; and
the flush circuit is further configured to flush the first relocation candidate data to a non-volatile memory device corresponding to the first target relocation buffer area.

3. The storage controller of claim 2, further comprising:
a collision probability calculation circuit configured to calculate, based on the first plurality of potential collision counts, first to N-th collision probabilities for the first relocation candidate data, the first to N-th collision probabilities respectively corresponding to the first to N-th non-volatile memory devices, and
wherein the preliminary relocation circuit is further configured to determine the first target relocation buffer area based on the first to N-th collision probabilities.

4. The storage controller of claim 3, wherein the preliminary relocation circuit is configured to,
calculate first to N-th relocation priorities respectively corresponding to the first to N-th non-volatile memory devices, based on an occupancy rate of each of the first to N-th relocation buffer areas and the first to N-th collision probabilities; and
determine the first target relocation buffer area based on the first to N-th relocation priorities.

5. The storage controller of claim 2, wherein a non-volatile memory device corresponding to the first target relocation buffer area corresponds to a different channel or a different way from a non-volatile memory device comprising the first relocation candidate physical address.

6. The storage controller of claim 1, wherein
the relocation buffer circuit includes a first to N-th relocation buffer areas respectively corresponding to first planes of the first to N-th non-volatile memory devices, and a N+1-th to 2N-th relocation buffer areas respectively corresponding to second planes of the first to N-th non-volatile memory devices;
the preliminary relocation circuit is configured to determine a second target relocation buffer area, which is one of the first to 2N-th relocation buffer areas, based on the first plurality of potential collision counts;
the flush circuit is further configured to flush the first relocation candidate data to a plane corresponding to the second target relocation buffer area; and
the plane corresponding to the second target relocation buffer area is different from a plane including the first relocation candidate physical address.

7. The storage controller of claim 1, further comprising:
a command buffer circuit configured to store one or more read commands generated based on host commands provided from an external host device; and
wherein the preliminary relocation circuit is configured to determine a physical address corresponding to a first read command lastly added to the command buffer circuit among the one or more read commands in the command buffer circuit as the first relocation candidate physical address.

8. The storage controller of claim 1, configured to determine one of the first to N-th plurality of physical addresses as the first relocation candidate physical address, based on the plurality of potential collision counts.

9. The storage controller of claim 1, further comprising:
a command buffer circuit configured to store one or more read commands generated based on host commands provided from an external host device,
wherein, in response to read commands for two or more physical addresses are included in the command buffer circuit at a same time point, the potential collision counter circuit is configured to increase the potential collision count, corresponding to the two or more physical addresses, among the plurality of potential collision counts.

10. A storage device, comprising:
a first non-volatile memory device configured to store a relocation candidate data;
a second non-volatile memory device; and
a storage controller configured to relocate the relocation candidate data from the first non-volatile memory device to the second non-volatile memory device, based on a first collision probability of when reading the relocation candidate data from the first non-volatile memory device and a second collision probability of when reading the relocation candidate data from the second non-volatile memory device.

11. The storage device of claim 10, wherein the storage controller includes,
a collision probability calculation circuit configured to calculate the first collision probability and the second collision probability;
a relocation buffer circuit including a first relocation buffer area corresponding to the first non-volatile memory device and a second relocation buffer area corresponding to the second non-volatile memory device;
a preliminary relocation circuit configured to store the relocation candidate data in the second relocation buffer area based on the first collision probability and the second collision probability; and
a flush circuit configured to flush the second relocation buffer area to the second non-volatile memory device.

12. The storage device of claim 11, wherein
the first non-volatile memory device includes a first plurality of physical addresses and a relocation candidate physical address storing and the relocation candidate data;
the second non-volatile memory device includes a second plurality of physical addresses;
the storage controller further includes a potential collision counter circuit configured to manage a first plurality of potential collision counts for the relocation candidate physical address respectively corresponding to the first plurality of physical addresses, and a second plurality of potential collision counts for the relocation candidate physical address respectively corresponding to the second plurality of physical addresses; and
the collision probability calculation circuit is configured to calculate the first collision probability based on the first plurality of potential collision counts, and calculate the second collision probability based on the second plurality of potential collision counts.

13. The storage device of claim 12, wherein,
the storage controller further includes a command buffer circuit configured to store one or more read commands generated based on host commands provided from an external host device; and
the potential collision counter circuit is configured to,
increase a first potential collision count, corresponding to a first physical address, among the first plurality of potential collision counts, in response to the command buffer circuit includes a first read command corresponding to the relocation candidate physical address and a second read command for the first physical address which is one of the first plurality of physical addresses; and
increase a second potential collision count corresponding to a second physical address among the second plurality of potential collision counts, in response to the command buffer circuit comprises the first read command and a third read command for the second physical address which is one of the second plurality of physical addresses.

14. The storage device of claim 11, wherein the preliminary relocation circuit configured to store the relocation candidate data in the second relocation buffer area, based on that a second relocation priority is greater than a first relocation priority,
wherein the first relocation priority is determined based on a first occupancy rate for the first relocation buffer area and the first collision probability; and
wherein the second relocation priority determined based on a second occupancy rate for the second relocation buffer area and the second collision probability.

15. The storage device of claim 11, wherein the storage controller is configured to read the relocation candidate data from the relocation buffer circuit in response to a read request for the relocation candidate data occurring while the relocation candidate data is stored in the relocation buffer circuit.

16. The storage device of claim 11, wherein the flush circuit is configured to flush the first and second relocation buffer areas to the first and second non-volatile memory devices, respectively, in response to the first and second relocation buffer area being in a full-state.

17. The storage device of claim 11, wherein the storage controller is configured to
control the first non-volatile memory device based on a first channel; and
control the second non-volatile memory device based on a second channel different from the first channel.

18. The storage device of claim 11, wherein the storage controller is configured to
control the first non-volatile memory device and the second non-volatile memory device based on a same channel each other; and
control the first non-volatile memory device and the second non-volatile memory device based on different ways each other.

19. A storage device, comprising:
a plurality of non-volatile memory devices including a plurality of physical addresses;
a command buffer circuit configured to store one or more read commands generated based on host commands provided from an external host device; and
a data relocation manager configured to,
during a first period, in response to a read command being added to the command buffer circuit, relocate data stored in a physical address corresponding to the added read command; and
during a second period, relocate a plurality of data each stored in the plurality of physical addresses, sequentially,
wherein an access from the external host device repeatedly occurs in the first period, and where the access from the external host device does not occur in the second period.

20. The storage device of claim 19, wherein
the external host device is configured to drive a neural network model; and
the neural network model performs an inference operation during the first period, and is in an idle state during the second period.
